(19) United States
(12) Patent Application Publication
(10) Pub. No.: US 2015/0132725 A1
(43) Pub. Date: May 14, 2015

(54) DISH INFORMATION PROVIDING METHOD AND SYSTEM

(71) Applicant: Panasonic Intellectual Property Corporation of America, Torrance, CA (US)

(72) Inventors: KAZUNORI OKUBO, Hyogo (JP); KOJI NAKANISHI, Osaka (JP); SHUNSUKE KUHARA, Osaka (JP); RYOTA FUJIMURA, Osaka (JP); KAZUTAKA FURUTA, Osaka (JP); KEIGO ASO, Osaka (JP)

(21) Appl. No.: 14/605,763

(22) Filed: Jan. 26, 2015

Related U.S. Application Data
(63) Continuation of application No. PCT/JP2014/002583, filed on May 16, 2014.

(30) Foreign Application Priority Data
May 30, 2013 (JP) 2013-113659

(51) Int. Cl. G09B 19/00

(52) U.S. Cl. CPC G09B 19/0092
USPC 434/127

(57) ABSTRACT

A dish information providing method comprising: performing obtaining the dish information items regarding dishes for the predetermined number of days that are recommended to a user from a dish information database in which the dish information items are stored; providing the user with the obtained dish information items; accepting, from the user, selection of one or more dish information items from among the dish information items provided to the user; performing, in a case where a dish information item among the dish information items provided to the user has not been selected by the user, obtaining an alternative dish information item that is recommended to the user in place of the not-selected dish information item from the dish information database in accordance with a condition determined from the one or more selected dish information items; and providing the user with the obtained alternative dish information item.

### BACKGROUND

1. Technical Field

The present disclosure relates to a method and a system for providing dish information items regarding dishes for a predetermined number of days.

2. Description of the Related Art

People (e.g., homemakers) who cook everyday sometimes find it a burden to plan meals for one week. In order to reduce the burden, there have been proposed various Internet-based systems for providing information regarding dishes for one week (e.g., a meal plan) selected from a wide variety of dishes (see, for example, Japanese Unexamined Patent Application Publication No. 2002-073774). In particular, services offered by systems that provide a one-week meal plan at Internet web sites such as E-recipe (registered trademark), Misbit.com, and COOKPAD (registered trademark) are already established.

### SUMMARY

However, further improvement of the system disclosed by Japanese Unexamined Patent Application Publication No. 2002-073774 is desired.

In one general aspect, the techniques disclosed here feature a dish information providing method including: performing a first process for obtaining the dish information items regarding dishes for the predetermined number of days that are recommended to a user from a dish information database in which the dish information items are stored; providing the user with the obtained dish information items; accepting, from the user, selection of one or more dish information items from among the dish information items provided to the user; performing, in a case where a dish information item among the dish information items provided to the user has not been selected by the user, a second process for obtaining an alternative dish information item that is recommended to the user in place of the not-selected dish information item from the dish information database in accordance with a condition determined from the one or more selected dish information items; and providing the user with the alternative dish information item obtained through the second process.

These general and specific aspects may be implemented using a system, a method, and a computer program, and any combination of systems, methods, and computer programs.

Exemplary embodiments of the present disclosure provide further improvement.

### BRIEF DESCRIPTION OF THE DRAWINGS

FIG. 1A is a diagram illustrating the overview of an information providing system.

FIG. 1B is a diagram illustrating a data operation center.

FIG. 1C is a diagram illustrating the data operation center.

FIG. 2 is a diagram illustrating a configuration of a dish information providing system.

FIG. 3 is a diagram illustrating a configuration of a server.

FIG. 4 is a diagram illustrating an example of a data structure of a dish information database.

FIG. 5 is a diagram illustrating an example of a data structure of a recipe information table.

FIG. 6 is a diagram illustrating an example of a data structure of a log information table.

FIG. 7 is a diagram illustrating an example of a data structure of provided dish information table.

FIG. 8 is a diagram illustrating a configuration of a mobile terminal.

FIG. 9 is a diagram illustrating an example of a data structure of a dish information table.

FIG. 10 is a diagram illustrating a menu screen.

FIG. 11 is a diagram illustrating how the screen changes when the screen is double tapped so as to display a character string “SELECTED”.

FIG. 12 is a diagram illustrating how the screen changes when the screen displaying the character string “SELECTED” is doubled tapped

FIG. 13 is a diagram illustrating how the screen changes in response to a flick operation.

FIG. 14 is a diagram illustrating how the screen changes when all dishes are selected.

FIG. 15 is a diagram illustrating how the screen changes when selection of all the dishes is confirmed.

FIG. 16 is a diagram illustrating how the screen changes when selection of all the dishes is redone.

FIG. 17 is a diagram illustrating how the screen changes when an icon button is tapped and held.

FIG. 18 is a diagram illustrating how the screen changes when a display area is tapped.

FIG. 19 is a diagram illustrating how the screen changes when a displayed image of a dish is single tapped in the case where the detailed type is “MENU”.

FIG. 20 is a diagram illustrating how the screen changes when a displayed image of a dish is single tapped in the case where the detailed type is “RECIPE”.

FIG. 21 is a diagram illustrating how the screen changes when a button is tapped.

FIG. 22 is a diagram illustrating how the screen changes in response to a swipe operation.

FIG. 23 is a flowchart illustrating a process performed by the mobile terminal and the server.

FIG. 24 is a flowchart illustrating a terminal-side event processing process and is continued to FIG. 25.

FIG. 25 is a flowchart illustrating the terminal-side event processing process and is continued from FIG. 24 and to FIG. 26.

FIG. 26 is a flowchart illustrating the terminal-side event processing process and is continued from FIG. 25.

FIG. 27 is a flowchart illustrating an updating process.

FIG. 28 is a flowchart illustrating a server-side event processing process and is continued to FIG. 29.

FIG. 29 is a flowchart illustrating the server-side event processing process which is continued from FIG. 28.

FIG. 30 is a flowchart illustrating a dish information obtaining process.

FIG. 31 is a flowchart illustrating a priority changing process.

FIG. 32 is a flowchart illustrating a display process and is continued to FIG. 33.

FIG. 33 is a flowchart illustrating the display process and is continued from FIG. 32.

FIG. 34 is a flowchart illustrating a specific example of the process performed by the mobile terminal and the server.

FIG. 35 is a diagram illustrating an own data center type model of cloud services.

FIG. 36 is a diagram illustrating an IaaS-type model of cloud services.

FIG. 37 is a diagram illustrating a PaaS-type model of cloud services.

FIG. 38 is a diagram illustrating an SaaS-type model of could services.

### DETAILED DESCRIPTION

### Underlying Knowledge of the Present Disclosure

The above-described systems are unsuitable for users who wish to decide on information regarding dishes for a predetermined number of days (e.g., meal plan) without taking much of their time.

For example, services offered by E-recipe and Misbit.com do not permit a user to customize the provided meal plan. Therefore, in the case where the provided one-week meal plan includes a dish that the user does not want, meals for all the days of the week are changed and a new meal plan is provided. In such a case, it can take a long time for a user to accept a provided meal plan for all the days of the week.

In addition, there are users who wish to decide on a one-week meal plan including a wide variety of dishes in consideration of nutrient balance. In such a case, for example, COOKPAD permits a user to select dishes from the provided one-week meal plan and provides an alternative for each dish not selected by the user. When an alternative is provided, the service may provide the same type of dish as the selected one regardless of the user's desire to eat a wide variety of dishes. In such a case, the user may request yet another alternative by not selecting the provided alternative. Therefore, even if this service is used, it may take a long time until meals for all the days of the week are confirmed. For this reason, it takes a long time until a one-week meal plan based on the user's desire is provided.

In addition, other users who are not good at cooking wish to be provided with a meal plan including dishes prepared in a procedure which they can perform. However, with the above-described systems, it is difficult to provide a meal plan of dishes prepared in a procedure which the user can perform from among a wide variety of dishes. As a result, a meal plan is provided multiple times and it takes a long time for the provided meal plan to contain dishes that can be prepared in a procedure which the user can perform.

In the case where a user is provided with information regarding dishes for a predetermined number of days (e.g., a meal plan), it is desirable to minimize the time taken until all information items regarding dishes for a predetermined number of days become satisfactory to the user.

Accordingly, the inventor has sought for an improved solution in order to provide another method for providing information regarding dishes for a predetermined number of days.

One aspect of the present exemplary embodiment features a dish information providing method including: performing a first process for obtaining the dish information items regarding dishes for the predetermined number of days that are recommended to a user from a dish information database in which the dish information items are stored; providing the user with the obtained dish information items; accepting, from the user, selection of one or more dish information items from among the dish information items provided to the user; performing, in a case where a dish information item among the dish information items provided to the user has not been selected by the user, a second process for obtaining an alternative dish information item that is recommended to the user in place of the not-selected dish information item from the dish information database in accordance with a condition determined from the one or more selected dish information items; and providing the user with the alternative dish information item obtained through the second process.

### Overview of Provided Service

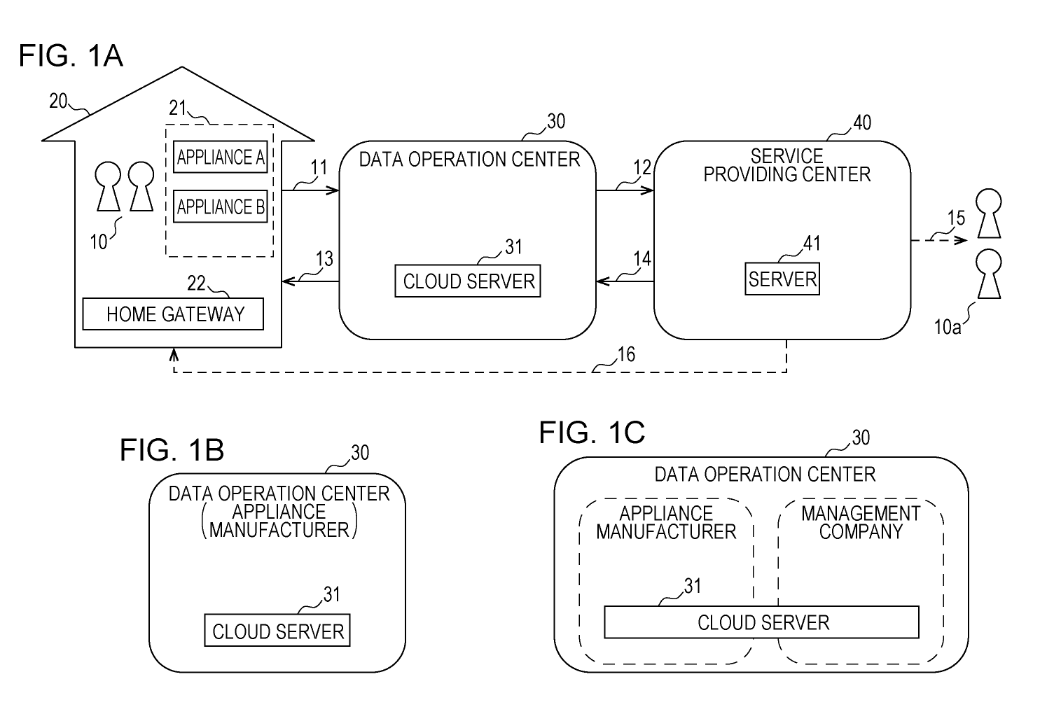

FIG. 1A illustrates the overview of an information providing system according to an exemplary embodiment.

A group 20 may be, for example, a company, organization, or home; and in any given scale. The group 20 includes a plurality of appliances 21 which include appliances A and B, and a home gateway 22. The plurality of appliances 21 may include appliances connectable to the Internet (e.g., a smartphone, a personal computer (PC), and a television (TV)) and appliances not connectable to the Internet on their own (e.g., a light, a washing machine, and a refrigerator). The plurality of appliances 21 may include appliances that are not connectable to the Internet on their own but are connectable to the Internet via the home gateway 22. The group 20 further includes users 10 who use the plurality of appliances 21.

A cloud server 31 is located at a data operation center 30. The cloud server 31 is a virtual server that operates in cooperation with various devices via the Internet. Typically, the cloud server 31 manages big data which is difficult to handle with an ordinary database management tool or the like. The data operation center 30 performs management and operation of the big data and the cloud server 31. Note that the data operation center 30 is not necessary a company that performs only data management and operation of the cloud server 31. For example, in the case where an appliance manufacture that develops and manufactures one of the plurality of apparatuses 21 also performs management of the data and the cloud server 31, the appliance manufacturer serves as the data operation center 30 (see FIG. 1B). In addition, the data operation center 30 is not necessarily run by one company. For example, in the case where an appliance manufacturer and another management company perform data management and operation of the cloud server 31 together or in a shared manner, both or one of the appliance manufacturer and the management company serves as the data operation center 30 (see FIG. 1C).

A service providing center 40 has a server 41. Herein, the server 41 may be in any given scale and may be, for example, a PC for personal use or the like.

Note that the home gateway 22 is not mandatory to the above-described service. For example, the home gateway 22 is not needed in the case where the cloud server 31 performs management of all data items. In addition, in some cases, appliances that are not connectable to the Internet on their own do not exist as in the case where every home appliance is connected to the Internet.

Now, the flow of information in the above-described service will be described.

First, the appliance A or B in the group 20 transmits its log information to the cloud server 31 at the data operation center 30. The cloud server 31 accumulates the log information of the appliance A or B (arrow 11). Note that log information is, for example, information representing the date and time when and how the users 10 used the plurality of appliances 21. For example, the log information includes a microwave-oven use log and an induction-cooktop use state. The log information is not limited to these particular types of information, and may include every information item that can be obtained from each appliance used for cooking, for example. The log information is sometimes provided directly to the cloud server 31 from the appliances A and B via the Internet, or is sometimes temporarily accumulated at the home gateway 22 from the appliances A and B and then provided to the cloud server 31 from the home gateway 22.

Then, the cloud server 31 at the data operation center 30 provides the accumulated log information to the service providing center 40 in constant units. Here, constant units may be units in which the data operation center 30 can organize and provide the accumulated information to the service providing center 40 or units requested by the data providing center 40. Although the term “constant units” is used here, the units need not be constant and an amount of provided information may vary depending on the circumstances. The log information is stored in the server 41 at the service providing center 40 if necessary (arrow 12). Then, the service providing center 40 obtains information matching the service provided to the user from the big data by using the log information, and provides the obtained information to the user. The user provided with the information may be the user 10 who uses the plurality of appliances 21 or an outside user 10a. In addition, the service providing center 40 obtains information to be provided to the user from the big data without using the log information depending on a type of the request from the user, and provides the obtained information to the user. As for the method for providing the service to the user, the information may be provided directly to the user from the service providing center 40 (arrows 15 and 16), for example. Alternatively, as for the method for providing the service to the user, the information may be provided to the user via the cloud server 31 at the data operation center 30 (arrows 13 and 14), for example. In addition, the cloud server 31 at the data operation center 30 may organize the log information into information matching the service to be provided to the user and provide the resulting information to the service providing center 40.

Note that the users 10 and 10a may be different persons or the same person. In addition, the cloud server 31 and the server 41 may be included in one apparatus. In this case, in one apparatus including the cloud server 31 and the server 41, the data operation center 30 manages big data and the service providing center 40 manages an application to be executed by the server 41 by using the big data. Also, by including the cloud server 31 and the server 41 in one apparatus, the log information no longer needs to be provided by the cloud server 31 to the server 41.

An exemplary embodiment of the present disclosure will be described blow.

### 1. Exemplary Embodiment

### 1.1 Regarding Dish Information Providing System 100

A dish information providing system 100 is a system that provides a user with information (hereinafter, referred to as dish information) regarding each of dishes for a predetermined number of days.

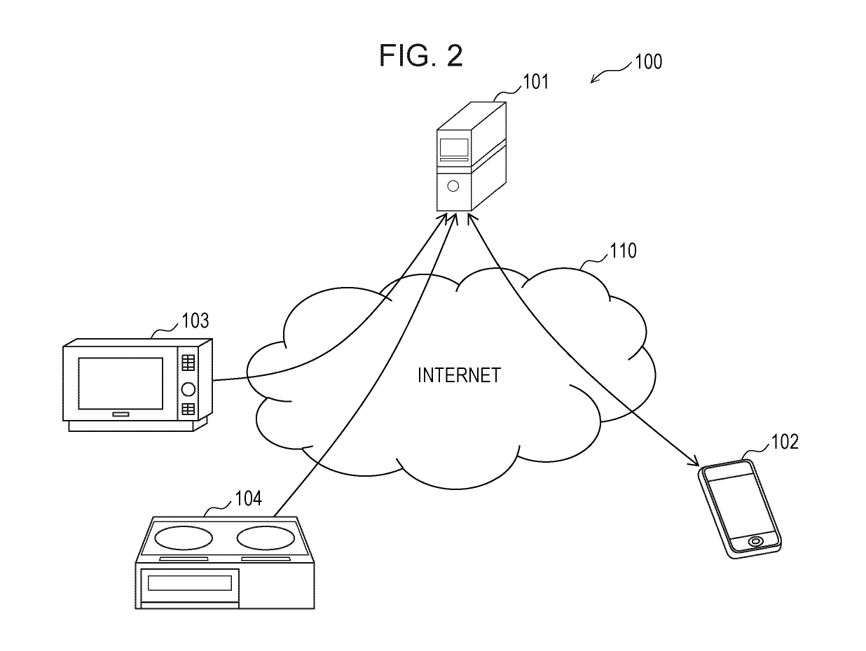

As illustrated in FIG. 2, the dish information providing system 100 includes a server 101, a mobile terminal 102, an appliance (hereinafter, referred to as a microwave oven) 103, and an appliance (hereinafter, referred to as an induction cooktop) 104.

The server 101 is an apparatus including the cloud server 31 and the server 41 illustrated in FIG. 1. The server 101 provides, using the mobile terminal 102 via Internet 110, the user with dish information items of dishes for a predetermined number of days selected from among a wide variety of dishes.

The mobile terminal 102 receives the provided dish information items for the predetermined number of days via the Internet 110.

The microwave oven 103 and the induction cooktop 104 are home electric appliances used by a user who uses the mobile terminal 102, and are included in the group 20 described above. When used by the user, the microwave oven 103 and the induction cooktop 104 transmit use log information to the server 101 via the Internet 110.

In FIG. 2, the server 101 provides dish information items for a predetermined number of days to one user; however, the server 101 provides dish information items for a predetermined number of days to a plurality of users in a practical case.

### 1.2 Server 101

Now, a configuration of the server 101 will be described.

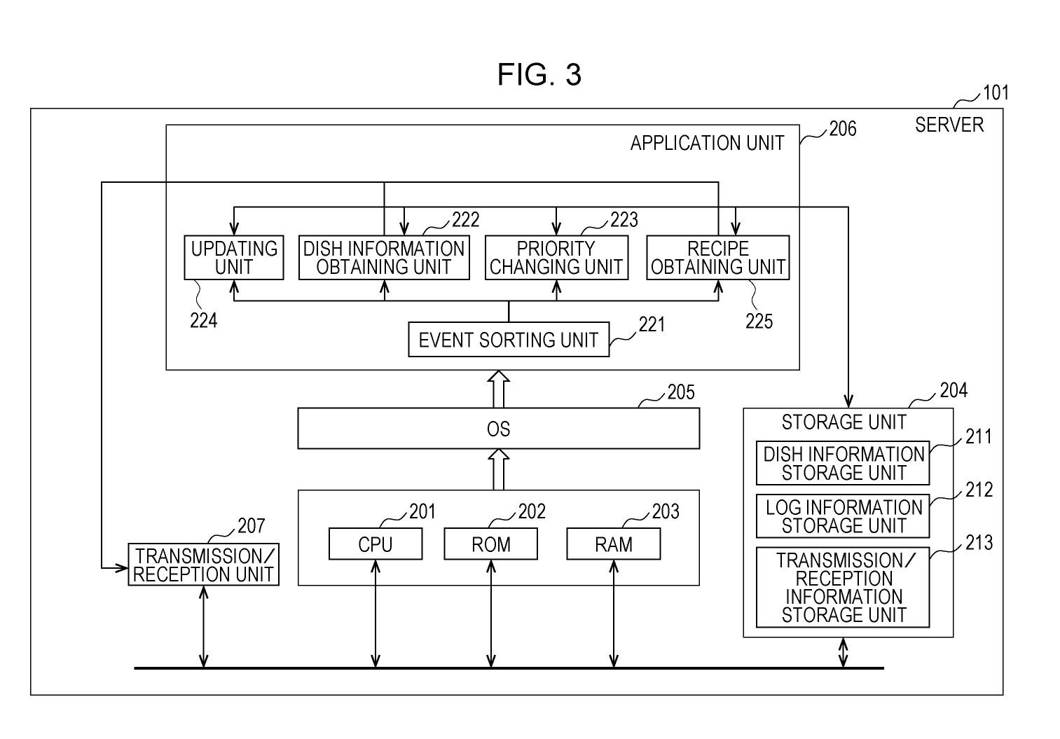

As illustrated in FIG. 3, the server 101 includes a central processing unit (CPU) 201, a read only memory (ROM) 202, a random access memory (RAM) 203, a storage unit 204, an operating system (OS) 205, an application unit 206, and a transmission/reception unit 207. For example, the storage unit 204 is a component of the cloud server 31 illustrated in FIG. 1 and the application unit 206 is a component of the server 41 illustrated in FIG. 1.

### 1) CPU 201, ROM 202, and RAM 203

The CPU 201, the ROM 202, and the RAM 203 form a computer system. A program stored in the ROM 202 is loaded into the RAM 203 by the CPU 201, and the loaded program and hardware resources operate in cooperation with each other to implement functions.

### 2) Storage Unit 204

The storage unit 204 is constituted by a large-capacity hard disk. As illustrated in FIG. 3, the storage unit 204 includes a dish information storage unit 211, a log information storage unit 212, and a transmission/reception information storage unit 213.

### 2.1) Dish Information Storage Unit 211

The dish information storage unit 211 is a storage area for storing information regarding a wide variety of dishes.

The dish information storage unit 211 includes a dish information database T100 and a recipe information table T200.

### 2.1.1) Dish Information Database T100

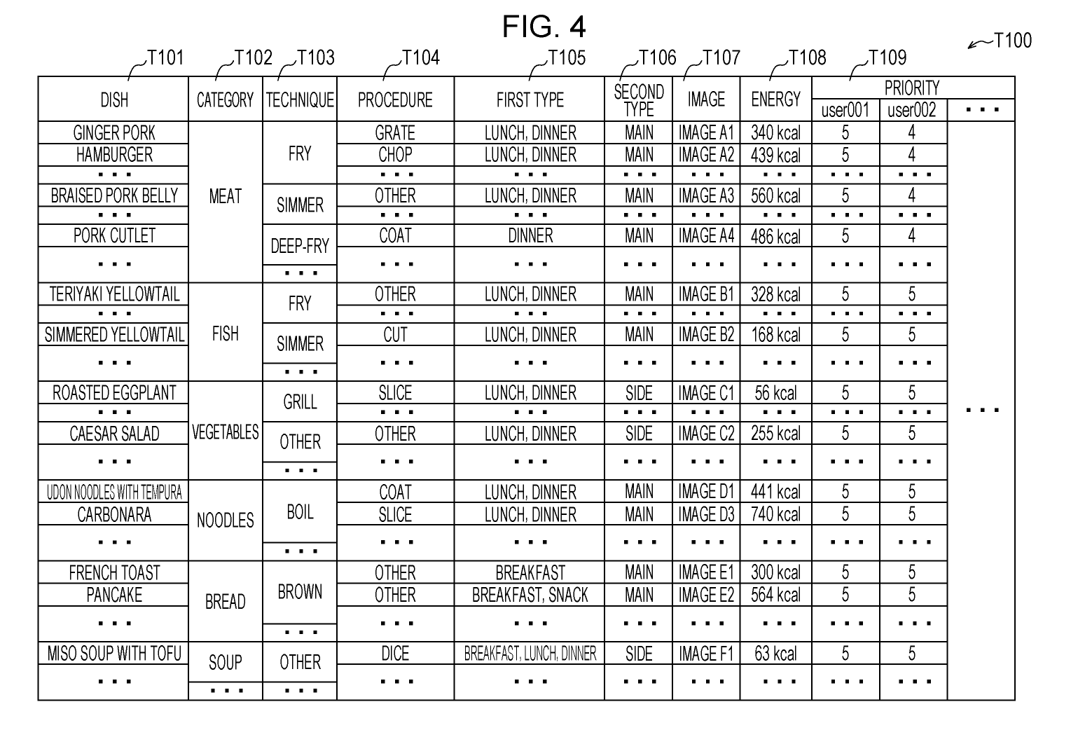

As illustrated in FIG. 4, the dish information database T100 stores a plurality of records each constituted by a dish name field T101, a category field T102, a technique field T103, a procedure field T104, a first type field T105, a second type field T106, an image field T107, an energy field T108, and a priority field T109.

The dish name field T101 stores a dish name provided to the user.

The category field T102 stores the name of a category of the dish indicated by the dish name. Examples of the category include “MEAT”, “FISH”, and “VEGETABLES”.

The technique field T103 stores a technique used to prepare the dish indicated by the dish name. Examples of the technique include “FRY”, “SIMMER”, and “DEEP-FRY”.

The procedure field T104 stores a name of a procedure performed to prepare the dish indicated by the dish name. Examples of the procedure include “GRATE” and “CHOP”.

The first type field T105 indicates which meal the dish indicated by the dish name is suitable for. For example, in the first type field T105, at least one of “BREAKFAST”, “LUNCH”, “DINNER”, and “SNACK” is set.

The second type field T106 indicates whether the dish indicated by the dish name is a main dish or a side dish.

The image field T107 stores data of an image of the dish indicated by the dish name (image data).

The energy field T108 stores an energy value (e.g., an energy value for 1 serving) of the dish indicated by the dish name.

The priority field T109 stores a value that is set on a user-by-user and dish-by-dish basis. Dish information items are obtained preferentially in descending order of the priority value.

Hereinafter, information including a dish name, an energy value, and image data of a dish indicated by the dish name is referred to as dish information or a dish information item.

### 2.1.2) Recipe Information Table T200

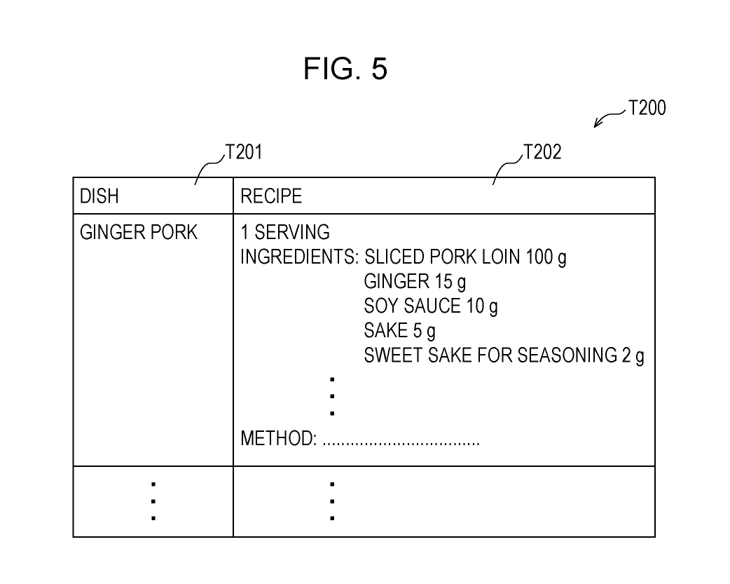

As illustrated in FIG. 5, the recipe information table T200 stores a plurality of records each constituted by a dish name field T201 and a recipe field T202.

The dish name field T201 stores a dish name.

The recipe field T202 stores information (hereinafter, referred to as recipe information) on the recipe of the dish indicated by the dish name. The recipe information includes information on the number of servings the dish indicated by the dish name is for, ingredients necessary for preparing the dish, and a method. Herein, the recipe information indicates ingredients for one serving.

### 2.2) Log Information Storage Unit 212

The log information storage unit 212 is a storage area for storing log information transmitted from the microwave oven 103 and the induction cooktop 104, and includes a log information table T300.

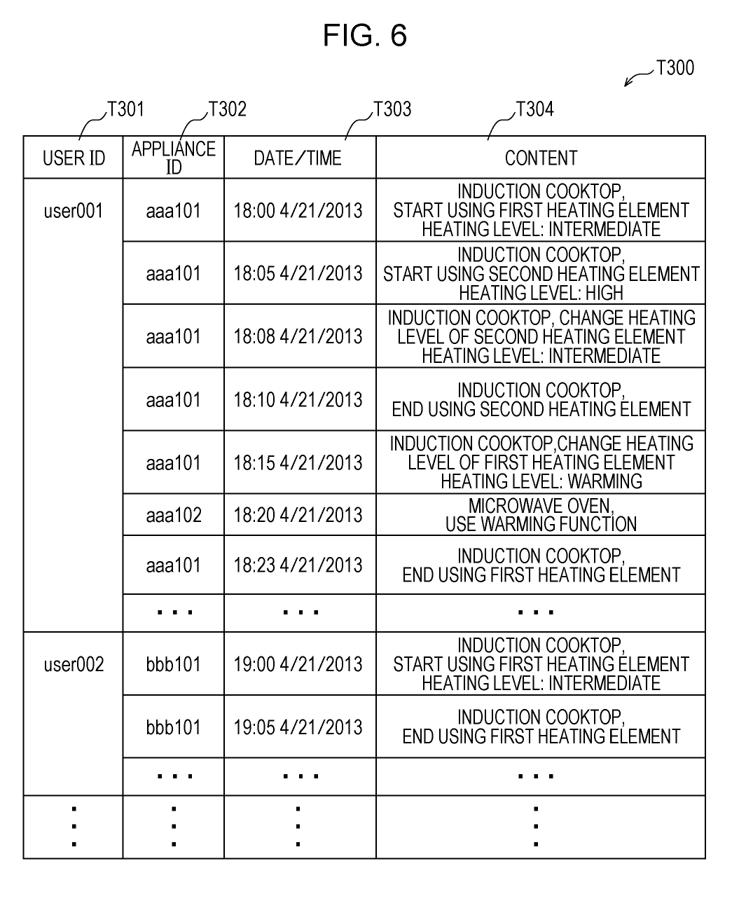

As illustrated in FIG. 6, the log information table T300 stores a plurality of records each constituted by a user identifier (ID) field T301, an appliance ID field T302, a date/time field T303, and a content field T304.

The user ID field T301 stores an ID identifying a user who uses the dish information providing system 100.

The appliance ID field T302 stores an ID identifying an appliance (e.g., the microwave oven 103 or the induction cooktop 104) used by the user. In this example, an appliance ID “aaa101” indicates the induction cooktop 104 used by a user identified by a user ID “user001”, whereas an appliance ID “aaa102” indicates the microwave oven 103 used by the same user.

The date/time field T303 stores a date and time of an event related to the use of the appliance.

The content field T304 stores details about the event related to the use of the appliance. For example, as for the induction cooktop 104, the content field T304 stores contents indicating the start and end of the use and the heating level (such as low, intermediate, or high) during the use. In addition, as for the microwave oven 103, the content field T304 stores contents indicating a function used among functions of the microwave oven 103.

### 2.3) Transmission/Reception Information Storage Unit 213

The transmission/reception information storage unit 213 is a storage area for storing dish information items that have been provided to a user and includes a provided dish information table T400.

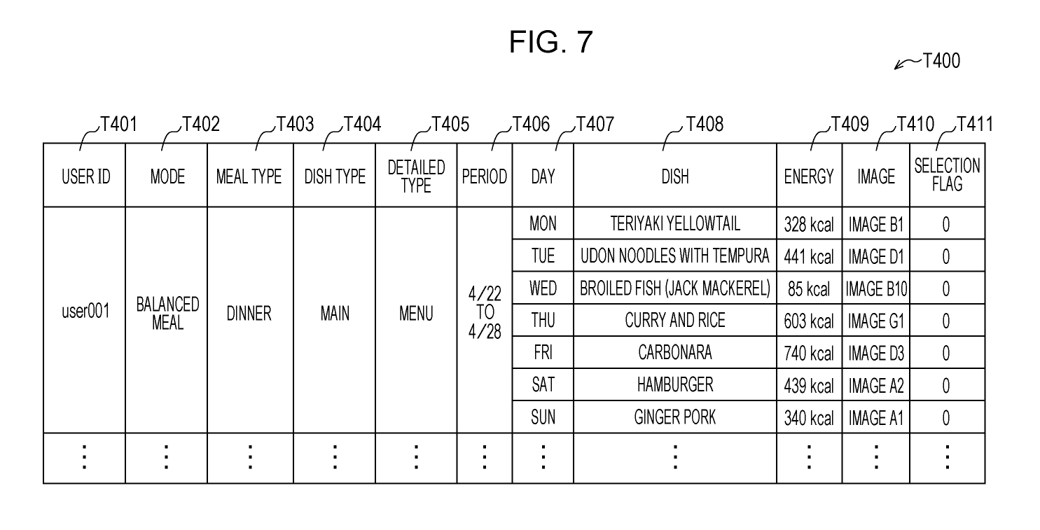

As illustrated in FIG. 7, the provided dish information table T400 stores a plurality of records each constituted by a user ID field T401, a mode field T402, a meal type field T403, a dish type field T404, a detailed type field T405, a period field T406, a day field T407, a dish name field T408, an energy field T409, an image field T410, and a selection flag field T411.

Like the user ID field T301, the user ID field T401 stores an ID identifying a user who uses the dish information providing system 100.

The mode field T402 stores a mode in accordance with which dish information is provided to the user. Specifically, in the mode field T402, either a balanced meal mode or a cooking interest mode is set. The balanced meal mode is a mode in which dish information items are provided without inclination to a specific category for a predetermined dish-information providing period. In addition, the cooking interest mode is a mode in which dish information items are provided in accordance with whether or not the user is interested in cooking. For example, in the case where the user is interested in cooking, the server 101 provides dish information items associated with different procedures for a predetermined dish-information providing period. In contrast, in the case where the user is not interested in cooking, the server 101 provides dish information items associated with similar procedures for the predetermined period.

The meal type field T403 indicates which of “BREAKFAST”, “LUNCH”, “DINNER”, or “SNACK” the provided dish information item is suitable for.

The dish type field T404 indicates whether the provided dish information item is regarding a main dish or a side dish of the meal indicated by the meal type field T403.

The detailed type field T405 indicates whether the dish information item is provided as a meal plan or a recipe.

The period field T406 indicates a predetermined number of days.

The day field T407 indicates each day of the week during the period indicated by the period field T406.

The dish name filed T408, the energy field T409, and the image field T410 are similar to the dish name field T101, the energy field T108, and the image field T107 illustrated in FIG. 4, respectively, and thus a description thereof will be omitted here. Note that, in the provided dish information table T400, a dish name, an energy value, and image data are respectively set in the dish name field T408, the energy field T409, and the image field T410 for each day of the week indicated by the day field T407.

The selection flag field T411 is associated with each day of the week indicated by the day field T407, and indicates whether or not the provided dish information is selected by the user. For example, the value “1” indicates that dish information provided for the corresponding day of the week is selected, whereas the value “0” indicates that dish information provided for the corresponding day of the week is not selected.

Hereinafter, a record constituted by the user ID field T401, the mode field T402, the meal type field T403, the dish type field T404, the detailed type field T405, the period field T406, the day field T407, the dish name field T408, the energy field T409, the image field T410, and the selection flag field T411 is referred to as transmission/reception information or a transmission/reception information item.

### 3) OS 205

The OS 205 is basic software for executing application programs implementing functions of the application unit 206 by operating in cooperation with hardware (e.g., the CPU 201, the ROM 202, and the RAM 203).

### 4) Application Unit 206

The application unit 206 is a specific unit in which an application program and hardware operate in cooperation with each other. As illustrated in FIG. 3, the application unit 206 includes an event sorting unit 221, a dish information obtaining unit 222, a priority changing unit 223, an updating unit 224, and a recipe obtaining unit 225.

### 4.1) Event Sorting Unit 221

Upon receipt of information regarding an event requested by the user of the mobile terminal 102, the event sorting unit 221 outputs the received information to one of the dish information obtaining unit 222, the priority changing unit 223, the updating unit 224, and the recipe obtaining unit 225 in accordance with the received information.

Specifically, the event sorting unit 221 receives one of menu request information, selection confirmation information, meal type change information, dish type change information, recipe request information, mode information, detailed type change information, and selection completion information from the mobile terminal 102.

Upon receipt of the menu request information, the meal type change information, or the dish type change information, the event sorting unit 221 outputs the received information to the dish information obtaining unit 222. Upon receipt of the selection confirmation information, the event sorting unit 221 outputs the received information to the priority changing unit 223. Upon receipt of the mode information, the detailed type change information, or the selection completion information, the event sorting unit 221 outputs the received information to the updating unit 224. Upon receipt of the recipe request information, the event sorting unit 221 outputs the received information to the recipe obtaining unit 225.

Each information will be described below.

The menu request information indicates a request for dish information items for a predetermined number of days, and contains a user ID, a mode, a meal type, a dish type, a detailed type, and a period.

The selection confirmation information indicates that some of the provided dish information items for the predetermined number of days have been accepted, and contains a user ID, dish names for the predetermined number of days, and selection flags for the respective dish names.

The meal type change information indicates that the meal type has been changed, and contains a user ID and a resulting meal type.

The dish type change information indicates that the dish type has been changed, and contains a user ID and a resulting dish type.

The recipe request information is a request for a recipe, and contains a user ID and a dish name for which the user requests a recipe.

The mode information indicates that the mode has been changed, and contains a user ID and a resulting mode.

The detailed type change information indicates that the detailed type has been changed, and contains a user ID and a resulting detailed type.

The selection completion information indicates that all the provided dish information items have been accepted, and contains a user ID.

### 4.2) Dish Information Obtaining Unit 222

In the case where the menu request information, the meal type change information, or the dish type change information is received from the mobile terminal 102 or upon receipt of an instruction to obtain a dish information item from the priority changing unit 223 (described later), the dish information obtaining unit 222 obtains one or more dish information items from the dish information database T100 and transmits the obtained dish information items to the mobile terminal 102 via the transmission/reception unit 207.

In addition, upon receipt of the menu request information from the event sorting unit 221, the dish information obtaining unit 222 updates the provided dish information table T400 by using the received menu request information and the dish information items obtained from the dish information database T100. Specifically, the dish information obtaining unit 222 stores the user ID, the mode, the meal type, the dish type, the detailed type, and the period contained in the menu request information in the user ID field T401, the mode field T402, the meal type field T403, the dish type field T404, the detailed type field T405, and the period field T406, respectively. The dish information obtaining unit 222 also stores, for each day of the week, the dish name, the energy value, and the image data contained in a corresponding one of the obtained dish information items in the dish name field T408, the energy field T409, and the image field T410 associated with the user ID of the transmission destination user, respectively.

Upon receipt of the meal type change information or the dish type change information from the event sorting unit 211, the dish information obtaining unit 222 updates the provided dish information table T400 in accordance with the received information.

### 4.3) Priority Changing Unit 223

The priority changing unit 223 changes the priority assigned to each dish name in the dish information database T100 by using the selection confirmation information received from the event sorting unit 221 in accordance with the mode set in the provided dish information table T400. The priority changing unit 223 also updates the value of the selection flag field T411 contained in the provided dish information table T400.

The priority changing unit 223 will be specifically described below.

The priority changing unit 223 updates the value of the selection flag associated with the dish name contained in each dish information item provided to the user indicated by the user ID contained in the received selection confirmation information to the value of the selection flag associated with the same dish name in the received selection confirmation information.

In the case where the mode is the “balanced meal mode”, the priority changing unit 223 changes the priority of each dish assigned to the user indicated by the user ID contained in the received selection confirmation information so as to make the priority for a dish name associated with the same category as any of the categories associated with the dish names whose selection flag value is “1” among the dish names contained in the selection confirmation information lower than the priority for a dish name not associated with any of the categories associated with the dish names whose selection flag value is “1”.

In the case where the mode is the “cooking interest mode” and the user is interested in cooking, the priority changing unit 223 changes the priority of each dish assigned to the user indicated by the user ID contained in the received selection confirmation information so as to make the priority for a dish name associated with the same procedure as any of the procedures associated with dish names whose selection flag value is “1” among the dish names contained in the selection confirmation information lower than the priority for a dish name not associated with any of the procedures associated with the dish names whose selection flag value is “1”.

In the case where the mode is the “cooking interest mode” and the user is not interested in cooking, the priority changing unit 223 changes the priority of each dish assigned to the user indicated by the user ID contained in the received selection confirmation information so as to make the priority for a dish name associated with the same procedure as any of the procedures associated with dish names whose selection flag value is “1” among the dish names contained in the selection confirmation information higher than the priority for a dish name not associated with any of the procedures associated with the dish names whose selection flag value is “1”.

In addition, the priority changing unit 223 lowers the priority of a deselected dish regardless of the set mode in the case where it is determined based on the selection flag value associated with each dish name contained in the received selection confirmation information that the dish indicated by the dish name is deselected.

After changing the priority in the dish information database T100, the priority changing unit 223 outputs, to the dish information obtaining unit 222, an instruction to obtain an alternative for the not-selected dish information in accordance with the priorities.

### 4.4) Updating Unit 224

The updating unit 224 updates the provided dish information table T400 by using the information received from the event sorting unit 221.

The updating unit 224 will be described specifically below.

Upon receipt of the mode information from the event sorting unit 221, the updating unit 224 changes the content of the mode field of the transmission/reception information item containing the same user ID as that contained in the mode information among the transmission/reception information items stored in the provided dish information table T400 to the mode contained in the received mode information.

Upon receipt of the detailed type change information from the event sorting unit 221, the updating unit 224 changes the content of the detailed type field of the transmission/reception information item containing the same user ID as that contained in the detailed type change information among the transmission/reception information items stored in the provided dish information table T400 to the detailed type contained in the received detailed type change information.

Upon receipt of the selection completion information from the event sorting unit 221, the updating unit 224 stores the transmission/reception information item containing the same user ID as that contained in the selection completion information among the transmission/reception information items stored in the provided dish information table T400 in a predetermined area (not illustrated) of the storage unit 204. Separately storing each dish information item accepted by the user makes it possible to check the dish information items for a predetermined number of days later.

### 4.5) Recipe Obtaining Unit 225

The recipe obtaining unit 225 obtains recipe information of a dish desired by the user from the recipe information table T200 by using the recipe request information received from the event sorting unit 221, and transmits the obtained recipe information to the mobile terminal 102 via the transmission/reception unit 207.

Specifically, the recipe obtaining unit 225 obtains recipe information associated with a dish name that matches the dish name contained in the recipe request information from the recipe information table T200.

### 5) Transmission/Reception Unit 207

The transmission/reception unit 207 includes a network interface card (NIC). The transmission/reception unit 207 receives, via the Internet 110, information transmitted from the mobile terminal 102 and log information transmitted from the microwave oven 103 and the induction cooktop 104. The transmission/reception unit 207 also transmits, via the Internet 110, information obtained by the dish information obtaining unit 222 to the mobile terminal 102.

### 1.3 Mobile Terminal 102

Now, a configuration of the mobile terminal 102 will be described.

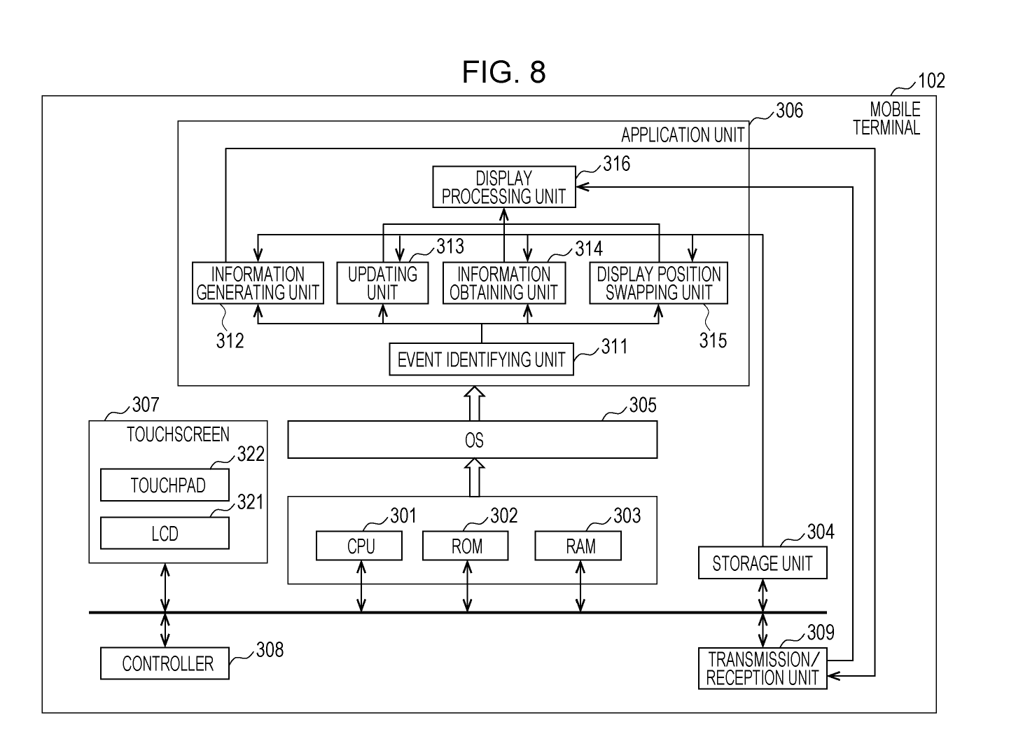

As illustrated in FIG. 8, the mobile terminal 102 includes a CPU 301, a ROM 302, a RAM 303, a storage unit 304, an OS 305, an application unit 306, a touchscreen 307, a controller 308, and a transmission/reception unit 309.

Upon receipt of dish information items for a predetermined number of days obtained by the server 101, the mobile terminal 102 displays a list of images of dishes contained in the received dish information items. This allows the user to recognize, for example, dishes for one week provided by the server 101 at a glance.

### 1) CPU 301, ROM 302, and RAM 303

The CPU 301, the ROM 302, and the RAM 303 form a computer system. A program stored in the ROM 302 is loaded into the RAM 303 by the CPU 301, and the loaded program and hardware resources operate in cooperation with each other to implement functions.

### 2) Storage Unit 304

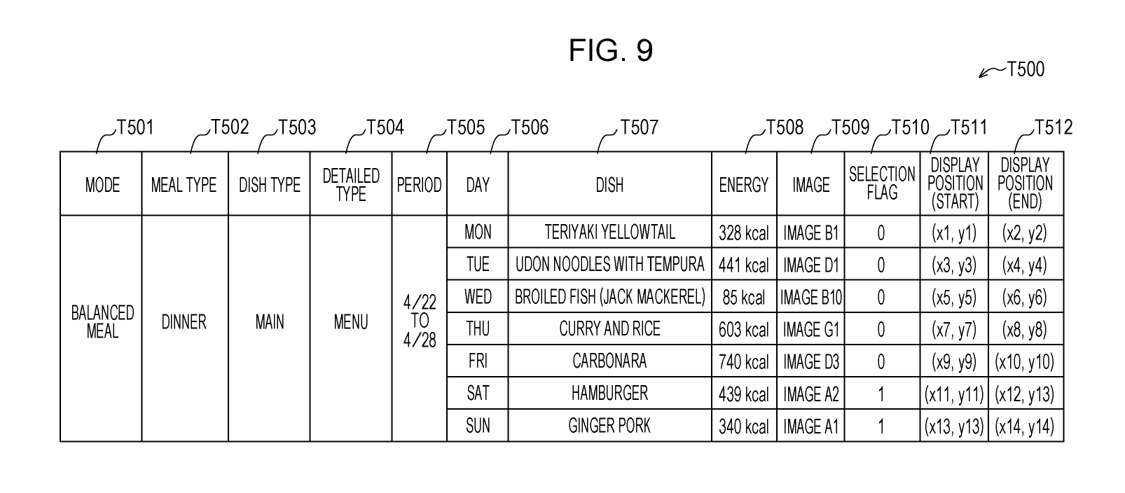

The storage unit 304 is constituted by a hard disk. As illustrated in FIG. 9, the storage unit 304 includes a dish information table T500 which stores information related to a request for and displaying of dish information.

As illustrated in FIG. 9, the dish information table T500 has an area for storing records each constituted by a mode field T501, a meal type field T502, a dish type field T503, a detailed type field T504, a period field T505, a day field T506, a dish name field T507, an energy field T508, an image field T509, a selection flag field T510, a display position (start) field T511, and a display position (end) field T512.

The mode field T501, the meal type field T502, the dish type field T503, the detailed type field T504, the period field T505, the day field T506, the dish name field T507, the energy field T508, the image field T509, and the selection flag field T510 are similar to the mode field T402, the meal type field T403, the dish type field T404, the detailed type field T405, the period field T406, the day field T407, the dish name field T408, the energy field T409, the image field T410, and the selection flag field T411 illustrated in FIG. 7, respectively, and thus a description thereof will be omitted here.

The display position (start) field T511 and the display position (end) field T512 indicate a display position where an image of a dish indicated by each dish information item obtained by the server 101 is displayed in a rectangular shape. Specifically, the display position (start) field T511 stores coordinates representing one vertex of a rectangle and the display position (end) field T512 stores coordinates of another vertex located diagonally to the one vertex indicated in the display position (start) field T511.

### 3) OS 305

The OS 305 is basic software for executing application programs implementing functions of the application unit 306 by operating in cooperation with hardware (e.g., the CPU 301, the ROM 302, and the RAM 303).

### 4) Application Unit 306

The application unit 306 is a specific unit in which an application program and hardware operate in cooperation with each other. As illustrated in FIG. 8, the application unit 306 includes an event identifying unit 311, an information generating unit 312, an updating unit 313, an information obtaining unit 314, a display position swapping unit 315, and a display processing unit 316.

### 4.1) Event Identifying Unit 311

In accordance with content of an instruction accepted from a user, the event identifying unit 311 notifies one of the information generating unit 312, the updating unit 313, the information obtaining unit 314, and the display position swapping unit 315 of the accepted instruction.

### 4.2) Information Generating Unit 312

The information generating unit 312 generates information to be transmitted to the server 101.

Specifically, in accordance with content of the instruction accepted from the user, the information generating unit 312 generates menu request information, selection confirmation information, meal type change information, dish type change information, detailed type change information, recipe request information, mode information, or selection completion information; and transmits the generated information to the server 101 via the transmission/reception unit 309.

In the case of generating the menu request information, the information generating unit 312 stores the user ID, the mode, the meal type, the dish type, the detailed type, and the period contained in the generated menu request information in the mode field T501, the meal type field T502, the dish type field T503, the detailed type field T504, and the period field T505 of the dish information table T500, respectively.

### 4.3) Updating Unit 313

In accordance with content of the instruction accepted from the user, the updating unit 313 updates content of the dish information table T500.

Specifically, the updating unit 313 updates the selection flag of a dish information item selected or deselected by the user among individual dish information items provided by the server 101.

### 4.4) Information Obtaining Unit 314

The information obtaining unit 314 obtains, from the dish information table T500, information to be displayed along with an image represented by image data contained in each dish information item provided by the server 101 or information to be displayed instead of such an image.

The information to be displayed along with an image is, for example, an energy value contained in the corresponding dish information item. The information to be displayed instead of an image is, for example, a combination of a dish name, an energy value, and an image contained in the corresponding dish information item. Hereinafter, information composed of a dish name, an energy value, and an image is referred to as detailed information or a detailed information item.

When display of the detailed information is switched back to the menu information, the information obtaining unit 314 obtains an image of a dish contained in each dish information item.

### 4.5) Display Position Swapping Unit 315

The display position swapping unit 315 swaps display positions of one image and another image among images of individual dish information items displayed on the touchscreen 307.

### 4.6) Display Processing Unit 316

The display processing unit 316 displays dish information items provided by the server 101.

For example, the display processing unit 316 displays a list of images represented by image data items contained in respective dish information items transmitted from the server 101 and displays recipe information. At this time, the display processing unit 316 stores the dish name, the energy value, and the image contained in each of the dish information items transmitted from the server 101 and the start and end display positions of the image represented by the image data contained in each of the dish information items in the dish name field T507, the energy field T508, the image field T509, the display position (start) field T511, and the display position (end) field T512 of the dish information table T500, respectively. The list of images of dishes represented by dish information items is displayed in a display format described later (e.g., a menu screen G100). Accordingly, display positions of images associated with individual days of the week are predetermined.

When a selection operation is accepted from the user while the menu is displayed, the display processing unit 316 superimposes a character string indicating the selected state on the displayed menu. In addition, when an instruction to display an energy value is accepted while the menu is displayed, the display processing unit 316 displays an energy value of each dish indicated by a corresponding image along with the image of the dish.

Specific display screens will be described later.

### 5) Touchscreen 307

The touchscreen 307 includes a liquid crystal display (LCD) 321 and a touchpad 322.

The touchpad 322 is a capacitive touch sensor and is provided on the LCD 321. Note that the touchpad 322 is formed of a transparent member, so that an image displayed on the LCD 321 is seen therethrough.

### 6) Controller 308

The controller 308 detects a touch of a user's finger or the like to the touchpad 322 of the touchscreen 307, and outputs coordinates of the touched position on the touchpad 322 to the CPU 301 at intervals of unit times (e.g., intervals of 25 ms) while detecting the touch.

### 7) Transmission/Reception Unit 309

The transmission/reception unit 309 includes an NIC. The transmission/reception unit 309 receives, via the Internet 110, information transmitted from the server 101 and transmits, via the Internet 110, information generated by the information generating unit 312 to the server 101.

### 1.4 Display Screen

### 1) Overview

The Overview of a displayed list of dish information items received from the server 101 will be described.

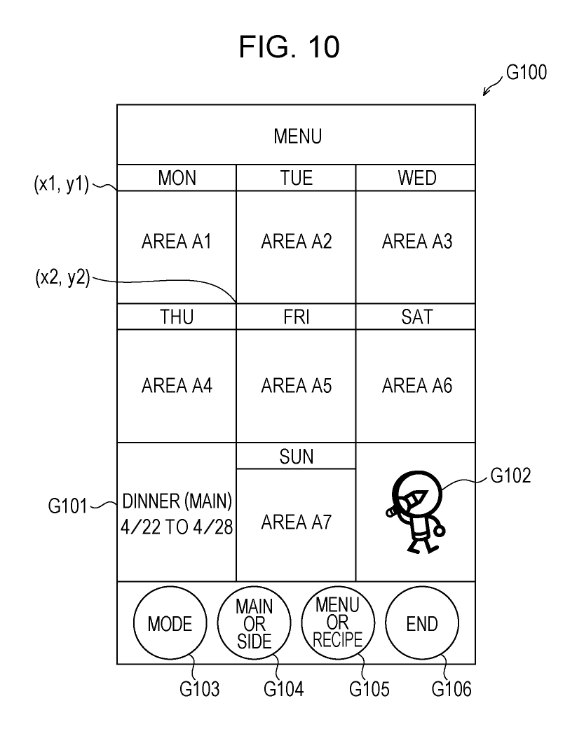

FIG. 10 illustrates the menu screen G100 that displays a list of dish information items received from the server 101.

The menu screen G100 includes areas A1 to A7. In each of the areas A1 to A7, an image of a dish associated with a day of the week displayed at the top of the area is displayed among images contained in the respective dish information items received from the server 101. By performing an operation such as a single tap or a double tap on the displayed image, the user can change the screen to the one corresponding to the operation.

In a display area G101, the meal type, the dish type, and the period for the displayed menu that are currently selected are displayed. The user can change the meal type by touching the display area G101.

An icon button G102 is a button for displaying or hiding the energy value. If the user taps the icon button G102 when the energy values of the dishes indicated by the displayed images are not displayed, the energy values of the dishes indicated by the images are displayed. If the user taps the icon button G102 when the energy values of the dishes indicated by the displayed images are displayed, the displayed energy values of the dishes indicated by the images are hidden.

A button G103 is a button for changing the mode.

A button G104 is a button for switching between the dish types to be displayed. If the user taps the button G104 when images of main dishes for the meal indicated by the meal type displayed in the display area G101 are displayed in the areas A1 to A7, the images of the dishes displayed in the areas A1 to A7 are switched to images of side dishes for the meal indicated by the meal type displayed in the display area G101. In addition, if the user taps the button G104 when images of side dishes of the meal indicated by the meal type displayed in the display area G101 are displayed in the areas A1 to A7, the images of the dishes displayed in the areas A1 and A7 are switched to images of main dishes of the meal indicated by the meal type displayed in the display area G101.

A button G105 is a button for switching the detailed type.

A button G106 is an end button. If the button G106 is tapped, displaying of the screen is ended.

### 2) Specific Examples

Operations performed on the screen of the mobile terminal 102 and how the screen changes in response to each operation will be described using specific examples.

### 2.1) First Specific Example

An operation performed on the screen to accept a dish information item provided by the server 101 and how the screen changes in response to the operation will be described.

To accept a dish information item provided by the server 101, the user double taps an image of a dish to be accepted on the displayed menu screen. Here, the term “double tap” refers to an operation in which a second touch is performed within a predetermined period (e.g., 0.5 seconds) from a first touch.

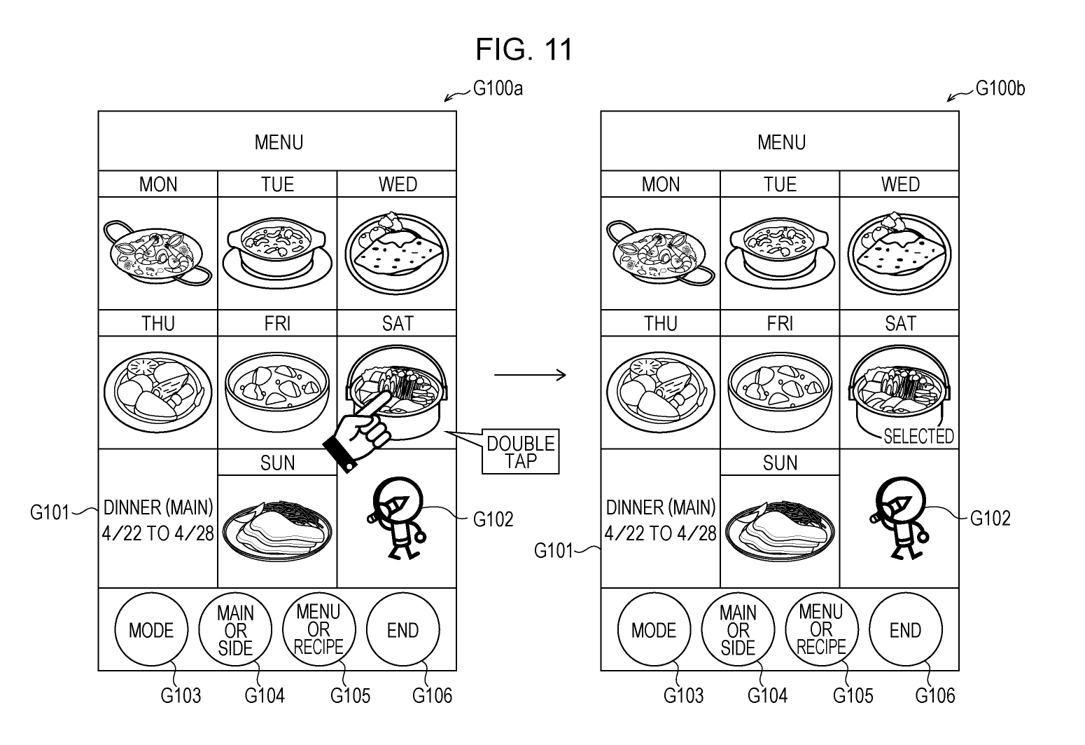

For example, as illustrated in FIG. 11, in the case of accepting a dish provided as the main dish for the Saturday dinner on a menu screen G100a which displays images of main dishes for dinner for Monday to Sunday, the user double taps the image of the dish.

Upon detection of the double tap, the mobile terminal 102 superimposes on the double tapped image a character string “SELECTED”, which indicates that the dish information item provided by the server 101 has been accepted (see a menu screen G100b of FIG. 11). Note that processing such as changing the screen is performed only by the mobile terminal 102 in response to this operation, and the server 101 is not aware of whether or not the provided dish information item has been accepted at this point. Accordingly, this accepting operation is referred to as a selection candidate accepting operation and a dish indicated by an image selected through this operation is referred to as a selection candidate.

### 2.2) Second Specific Example

Now, an operation performed on the screen to deselect a selected candidate and how the screen changes in response to the operation will be described.

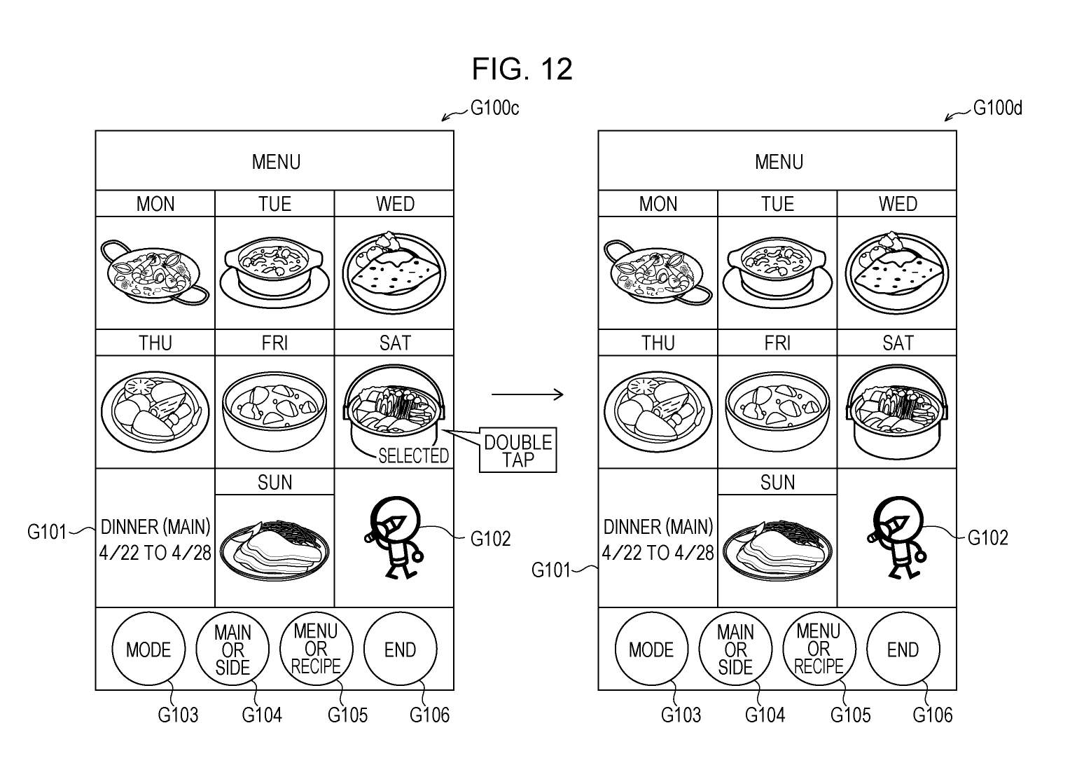

In the case of deselecting a selection candidate, the user double taps an image of a dish to be deselected. For example, when deselecting a dish for Saturday from the selection candidate on a menu screen G100c which includes an image of a selection candidate dish (i.e., the image of the dish for Saturday), the user double taps the image of the dish as illustrated in FIG. 12.

Upon detection of the double tap, the mobile terminal 102 hides the character string “SELECTED” that has been displayed on the double tapped image (see a menu screen G100d of FIG. 12).

### 2.3) Third Specific Example

Now, an operation performed on a screen to notify the server 101 of acceptance of provided dish information items and how the screen changes in response to the operation will be described.

To notify the server 101 that selection of the selection candidates is confirmed, the user flicks a displayed menu screen G100e. Here, the term “flicking” indicates an operation for quickly sliding a finger while keeping the finger in contact with the screen.

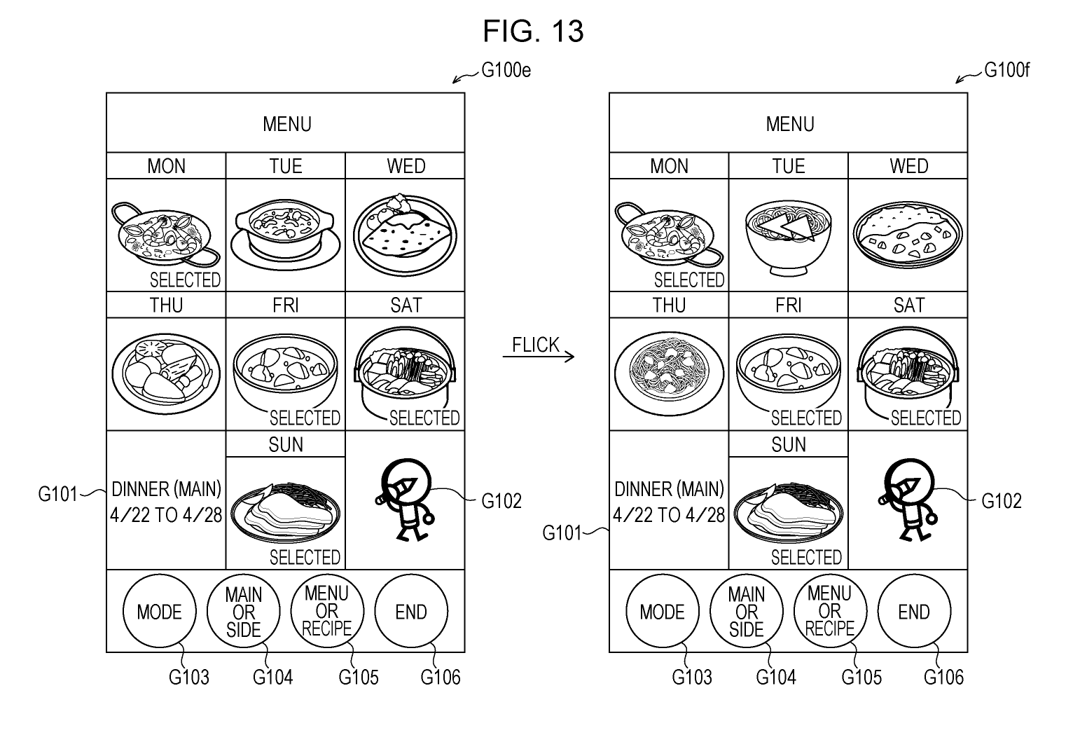

For example, when notifying the server 101 that selection of dishes for Monday, Friday, Saturday, and Sunday have been confirmed on the menu screen G100e which includes images of the selection candidate dishes (i.e., images of dishes for Monday, Friday, Saturday, and Sunday), the user performs a flick operation on this screen as illustrated in FIG. 13.

In response to the flick operation, the mobile terminal 102 keeps displaying the images of the dishes selected by the user along with the character string “SELECTED” and displays images of alternatives dishes in place of images of not-selected dishes that have been displayed for days of the week (here, Tuesday, Wednesday, and Thursday) (see a menu screen G100f of FIG. 13). Specifically, for days of the week for which dishes are not selected, images of dishes that are not associated with any of the categories associated with the selected dishes are displayed. For example, each of the dishes selected in the menu screen G100e of FIG. 13 is associated with one of the categories “FISH”, “VEGETABLES”, and “MEAT”. Accordingly, for days of the week for which dishes are not selected, images of dishes associated with categories “NOODLES (e.g., udon needles or pasta)” and “RICE (e.g., curry and rice)” are displayed.

### 2.4) Fourth Specific Example

Now, the case where a selection candidate accepting operation is performed for all dish information items will be described.

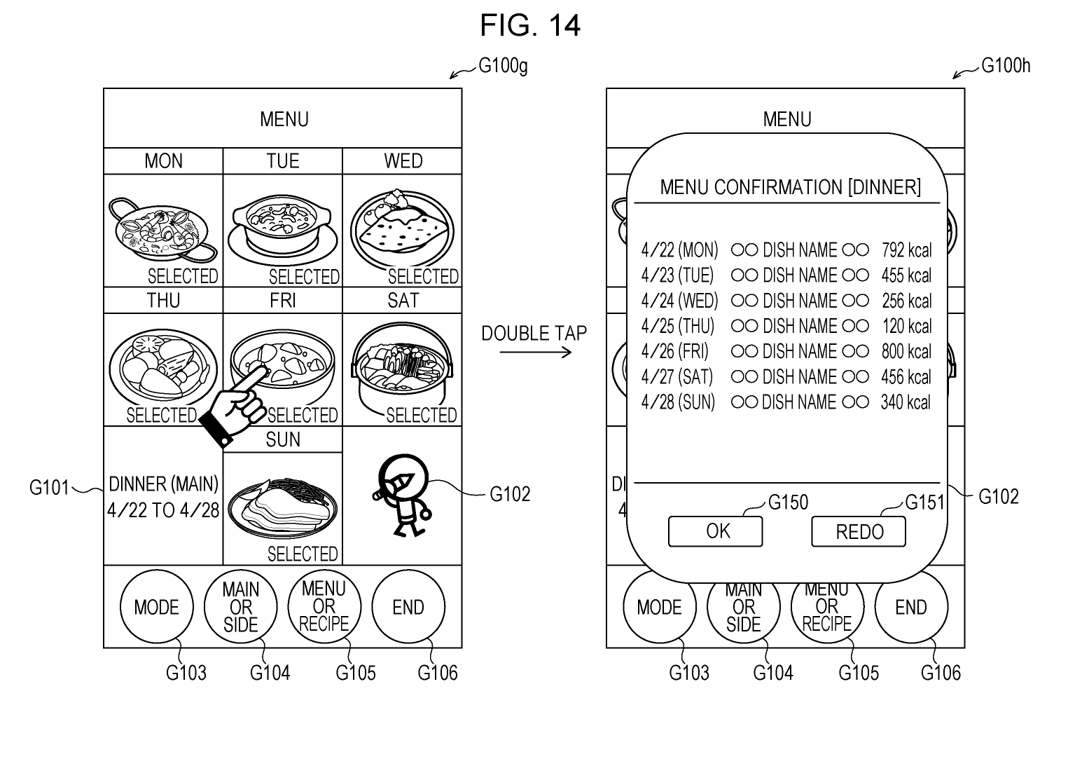

When the user double taps all the images of dishes (see a menu screen G100g of FIG. 14), a menu confirmation screen is displayed (see a screen G100h of FIG. 14). The menu confirmation screen displays dish names and energy values of dishes for Monday to Sunday and includes buttons G150 and G151.

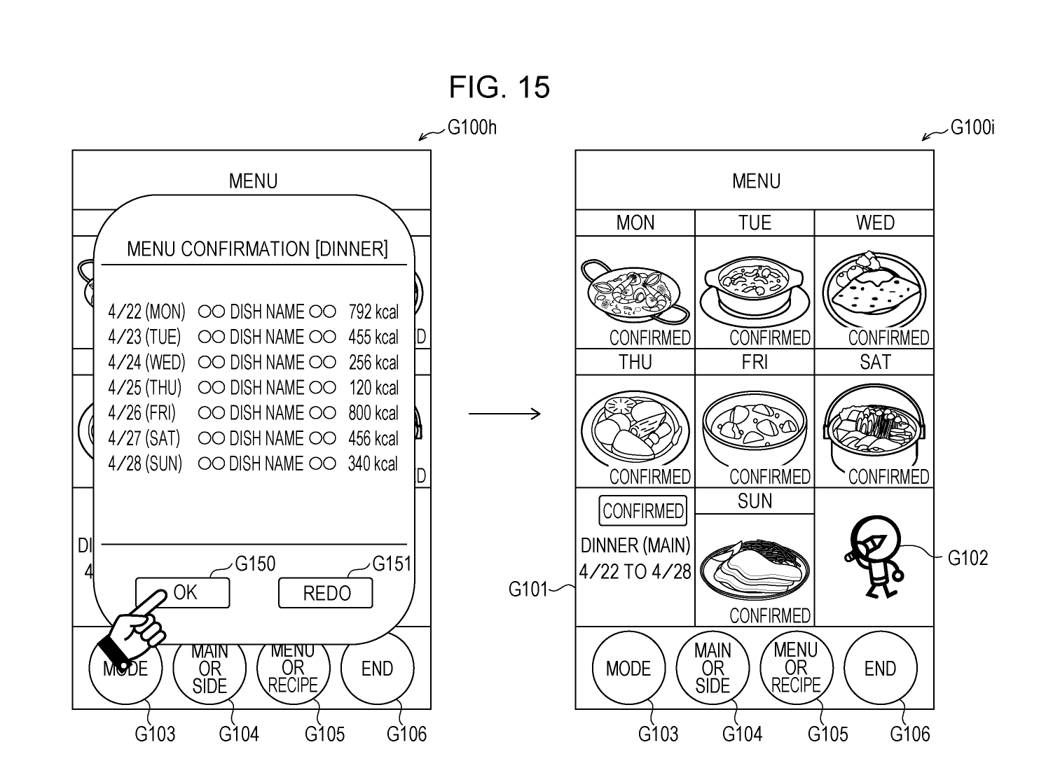

If the button G150 is tapped when the menu confirmation screen is displayed (see the screen G100h of FIG. 15), a character string “CONFIRMED” indicating that one-week meal plan has been confirmed is displayed in the display area G101 and further the character string “CONFIRMED” indicating that the meal for the day has been confirmed is displayed instead of the character string “SELECTED” that has been displayed along with the image of the dish (see a menu screen G100i of FIG. 15).

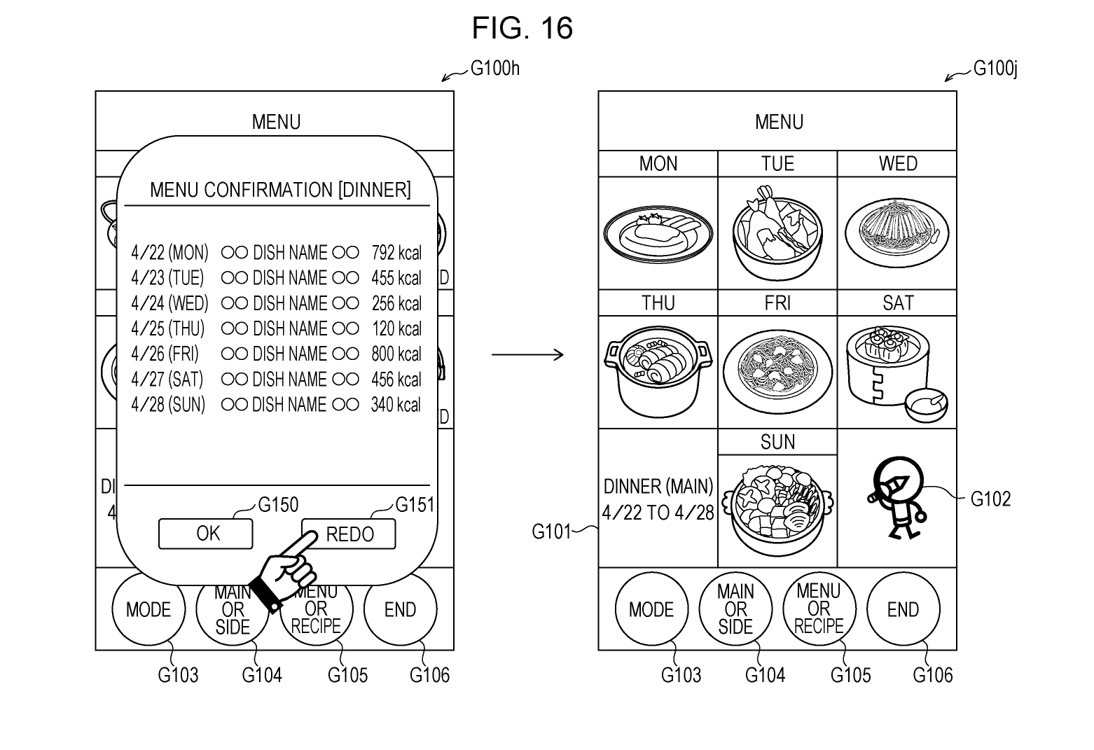

If the button G151 is tapped when the menu confirmation screen is displayed (see the screen G100h of FIG. 16), the images of dishes for all days of the week are changed to images of alternative dishes (see a menu screen G100j of FIG. 16).

### 2.5) Fifth Specific Example

Now, an operation performed on the screen to display energy values of the displayed dishes and how the screen changes in response to the operation will be described.

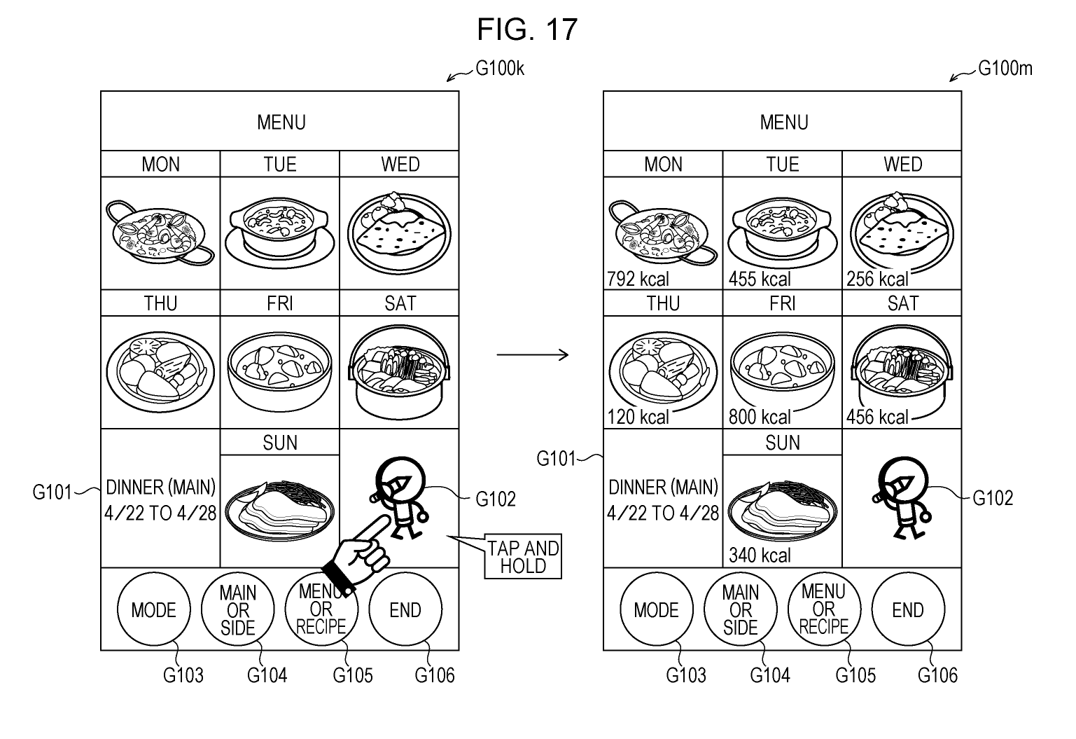

To display energy values of the displayed dishes, the user taps and holds (e.g., for one second) the icon button G102 on a displayed menu screen (see a menu screen G100k of FIG. 17).

Upon detection of the tapping and holding of the icon button G102, the mobile terminal 102 superimposes energy values of the dishes on the displayed images of the dishes (see a menu screen G100m of FIG. 17).

In addition, if the user taps and holds the icon button G102 on the menu screen G100m of FIG. 17, the energy values are hidden. That is, the menu screen G100k of FIG. 17 is displayed.

### 2.6) Sixth Specific Example

Now, an operation performed on the screen to change the meal type and how the screen changes in response to the operation will be described.

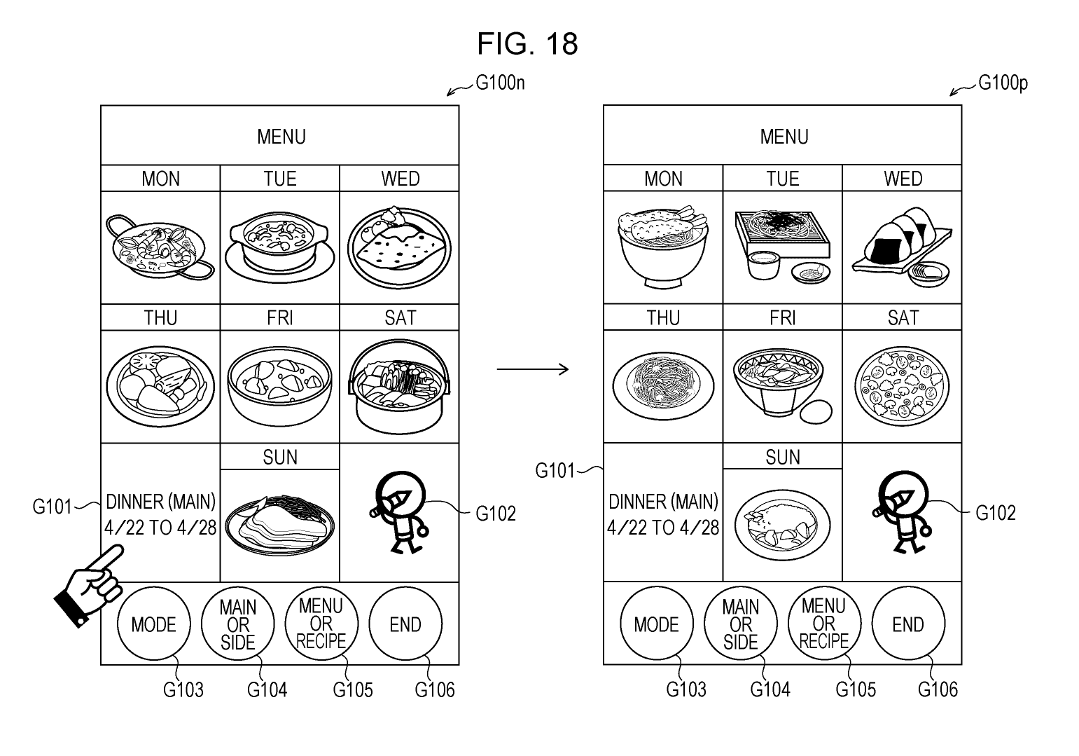

To change the meal type of the displayed dishes to another meal type, the user taps the display area G101 on the displayed menu screen (see a menu screen G100n of FIG. 18). In this embodiment, the meal type is changed every time the display area G101 is tapped. For example, the meal type is changed in the order of dinner, lunch, breakfast, snack, dinner, and so on in accordance with a predetermined rule.

Upon detection of the tap of the display area G101, the mobile terminal 102 changes content displayed in the display area G101 from the current meal type to another meal type that is selected in accordance with the number of times of tapping. For example, in the case where the current meal type is “DINNER” and the display area G101 is tapped once, the mobile terminal 102 changes the content displayed in the display area G101 from the current meal type “DINNER” to the meal type “LUNCH” based on the number of times the display area G101 has been tapped (see a menu screen G100p of FIG. 18).

### 2.7) Seventh Specific Example

Now, an operation performed on the screen to display detailed information or recipe information of one dish information item among individual dish information items provided by the server 101 and how the screen changes in response to the operation will be described.

To display detailed information or recipe information of one dish information item among individual dish information items provided by the server 101, the user single taps an image of a dish for which the user wishes to display the detailed information or the recipe information on the displayed menu screen. Here, the term “single tap” refers to an operation in which a touch is ended before a predetermined period (e.g., one second) passes after the start of the touch.

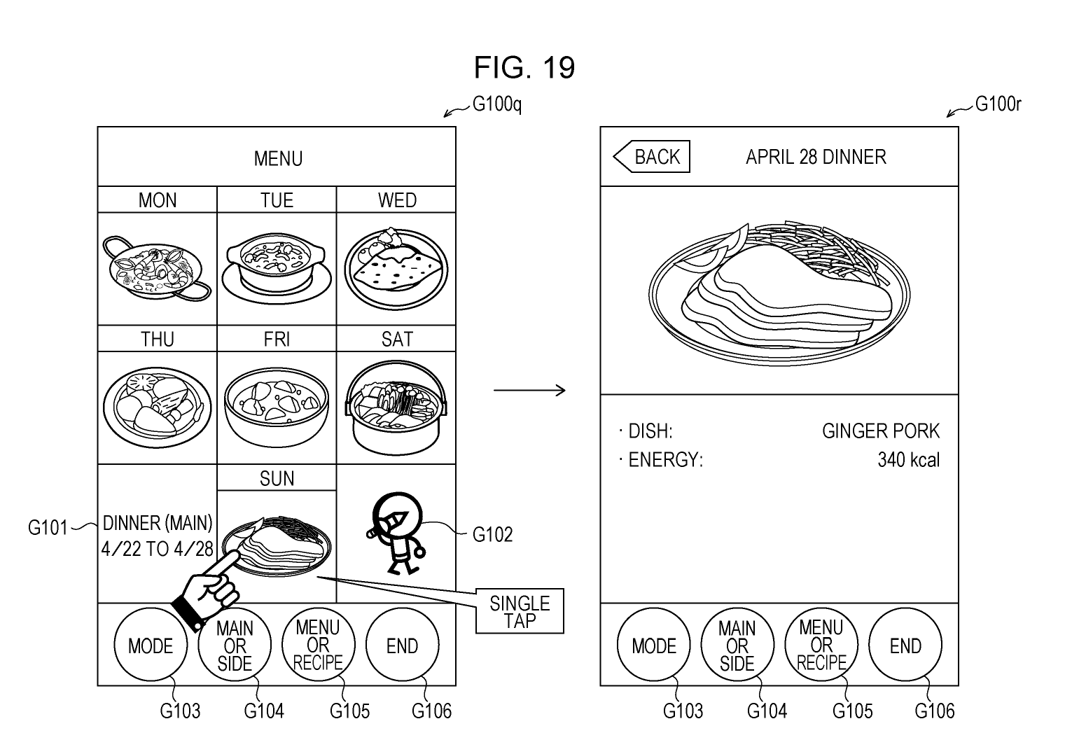

For example, in the case where the detailed type is “MENU” on a menu screen G100q which displays a list of images of main dishes for dinner for Monday to Sunday and the user wishes to see detailed information of a dish provided as the main dish for dinner for Sunday, the user single taps the image of the dish as illustrated in FIG. 19.

Upon detection of the single tap, the mobile terminal 102 displays detailed information of the dish indicated by the single tapped image on the screen (see a menu screen G100r of FIG. 19). The detailed information includes a dish name, an energy value, and an image of a dish indicated by the dish name as illustrated in the menu screen G100r of FIG. 19 and has the same content as the dish information item.

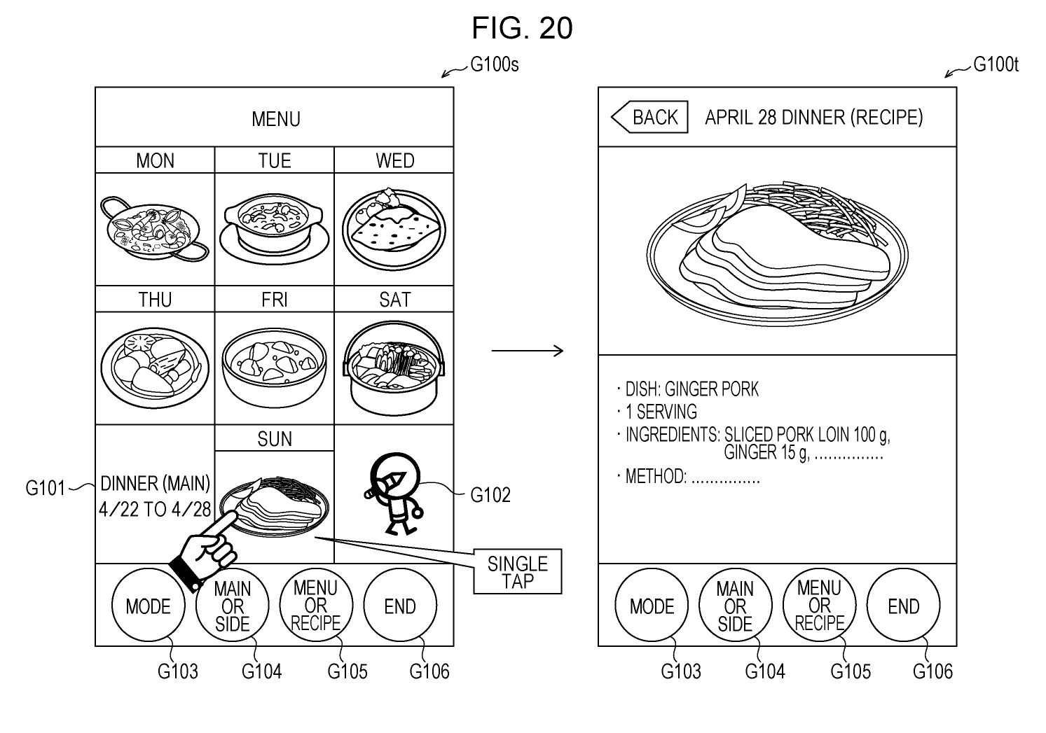

In addition, for example, in the case where the detailed type is “RECIPE” on a menu screen G100s which displays a list of images of main dishes for dinner for Monday to Sunday and the user wishes to see recipe information of a dish provided as the main dish for dinner for Sunday, the user single taps the image of the dish as illustrated in FIG. 20.

Upon detection of the single tap, the mobile terminal 102 displays recipe information of the dish indicated by the single tapped image along with the image of the dish associated with the recipe information (see a screen G100t of FIG. 20).

### 2.8) Eighth Specific Example

Now, an operation performed on the screen to switch between a menu of main dishes and a menu of side dishes and how the screen changes in response to this operation will be described.

To switching the display target from the main dish to the side dish or from the side dish to the main dish, the user taps the button G104.

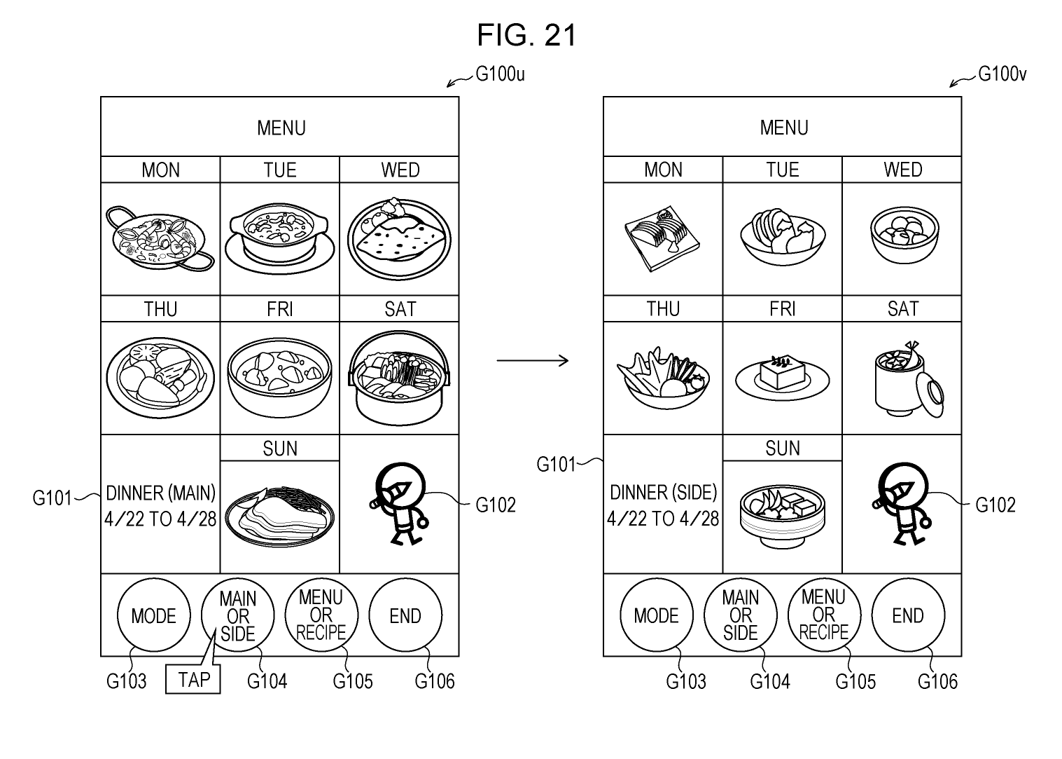

For example, when the user wishes to switch the display target to the side dishes for dinner on a menu screen G100u which displays a list of images of main dishes for dinner from Monday to Sunday, the user taps the button G104 as illustrated in FIG. 21.

Upon detection of the tap of the button G104, the mobile terminal 102 displays a list of side dishes for dinner on the screen (see a menu screen G100v of FIG. 21). Referring to FIG. 21, content displayed in the display area G101 is changed from information indicating that the displayed list is regarding main dishes to information indicating that the displayed list is regarding side dishes after the button G104 has been tapped.

### 2.9) Ninth Specific Example

Now, an operation performed on the screen to swap a dish associated with a certain day of the week and a dish associated with another day of the week among the dishes displayed as a list and how the screen changes in response to the operation will be described. In this case, the user performs an operation for swapping display positions of images of a certain dish and another dish.

To swap the display positions, the user performs a swipe operation. The term “swipe operation” refers to an operation in which an object is moved from a touched position while keeping the touch and then the touch on the object is ended.

Specifically, the user touches an image of a certain dish to be swapped, moves the position of the image while keeping touching the image to a position where an image of another dish to be swapped is displayed, and then stops touching the image.

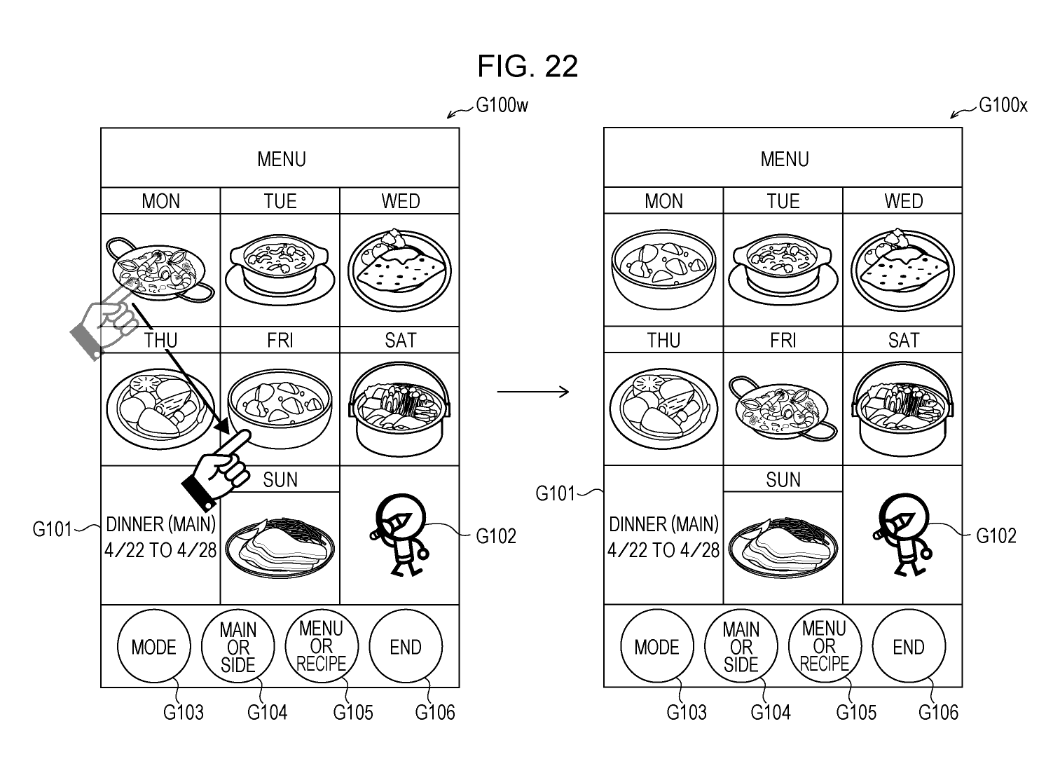

For example, when the user wishes to swap an image (first image) of a dish provided as the main dish for dinner for Monday and an image (second image) of a dish provided as the main dish for dinner for Friday on a menu screen G100w, the user touches the position where the first image is displayed, performs a swipe operation to move the first image to the position where the second image is displayed, and then stops touching the first image as illustrated in FIG. 22.

Upon detection of the swipe operation, the mobile terminal 102 swaps the image (here, the first image) displayed at the operation start position and the image (here, the second image) displayed at the operation end position (see a menu screen G100x of FIG. 22).

### 1.5 Operation

Now, an operation performed by the dish information providing system 100 will be described.

### 1) Operation of Dish Information Providing System 100

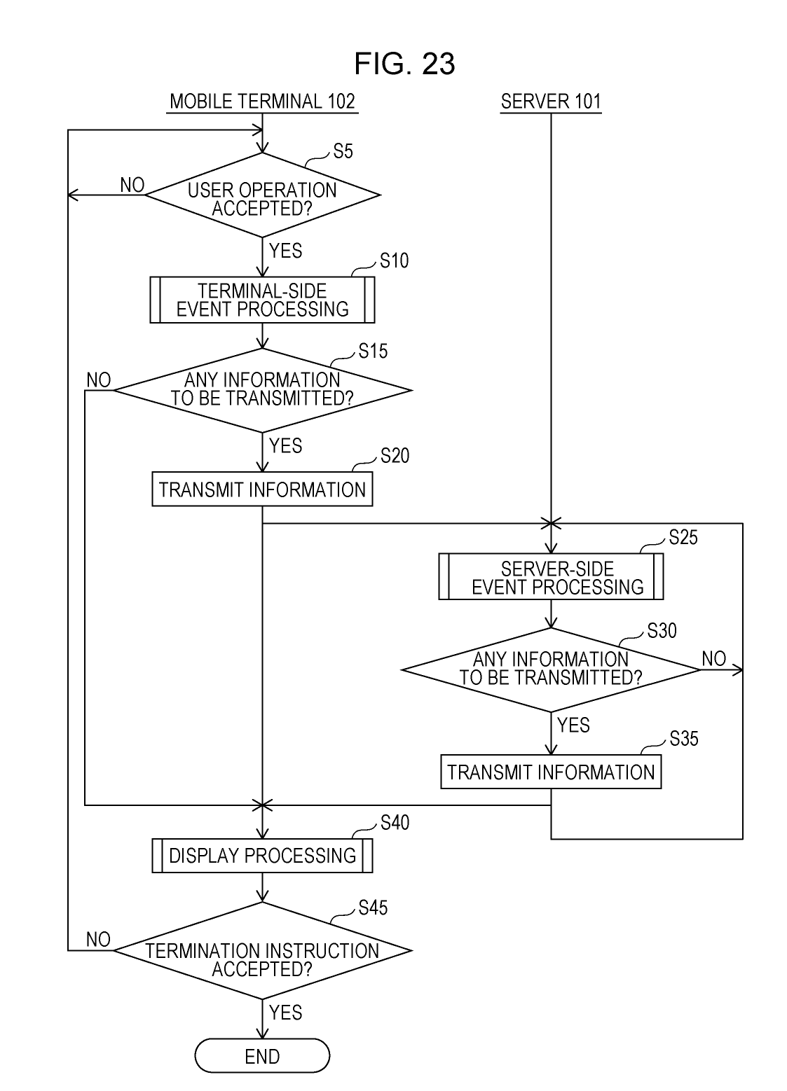

Referring now to a flowchart of FIG. 23, an operation performed by the dish information providing system 100 will be described.

The mobile terminal 102 determines whether or not it has accepted a user operation (step S5).

Upon determining that the mobile terminal 102 has accepted a user operation (“YES” in step S5), the mobile terminal 102 performs a terminal-side event processing process (step S10). Details about the terminal-side event processing process will be described later.

The mobile terminal 102 determines whether or not information to be transmitted to the server 101 has been generated through the terminal-side event processing process (step S15).

Upon determining that information to be transmitted has been generated (“YES” in step S15), the mobile terminal 102 transmits the information to the server 101 (step S20).

Upon receipt of the information transmitted from the mobile terminal 102, the server 101 performs a server-side event processing process (step S25). Details about the server-side event processing process will be described later.

The server 101 determines whether or not information to be transmitted to the mobile terminal 102 has been generated through the server-side event processing process (step S30).

Upon determining that information to be transmitted to the mobile terminal 102 has been generated (“YES” in step S30), the server 101 transmits the information to the mobile terminal 102 (step S35).

Upon determining that information to be transmitted to the mobile terminal 102 has not been generated (“NO” in step S30), the server 101 waits for information transmitted from the mobile terminal 102.

Upon determining that information to be transmitted to the server 101 has not been generated (“NO” in step S15) or upon receipt of information transmitted from the server 101, the mobile terminal 102 performs a display process (step S40). Details about the display process will be described later.

The mobile terminal 102 determines whether or not it has accepted an instruction to terminate the process (step S45).

Upon determining that an instruction to terminate the process has not been received (“NO” in step S45) or upon determining that a user operation has not been accepted (“NO” in step S5), the mobile terminal 102 waits for a user operation.

Upon determining that an instruction to terminate the process has been accepted (“YES” in step S45), the process ends.

### 2) Terminal-Side Event Processing Process

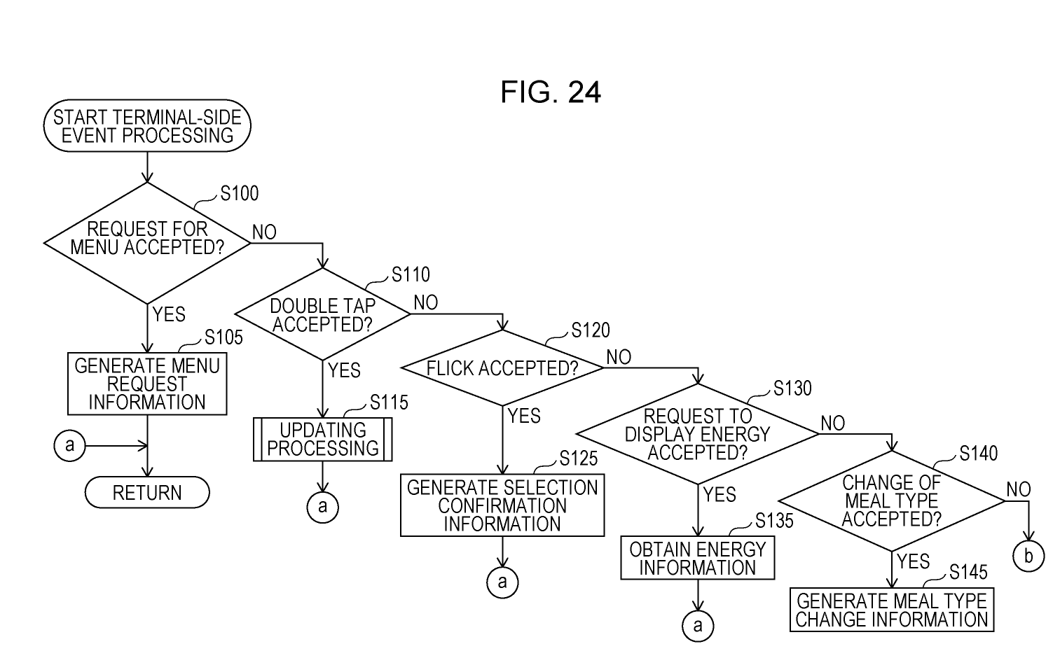

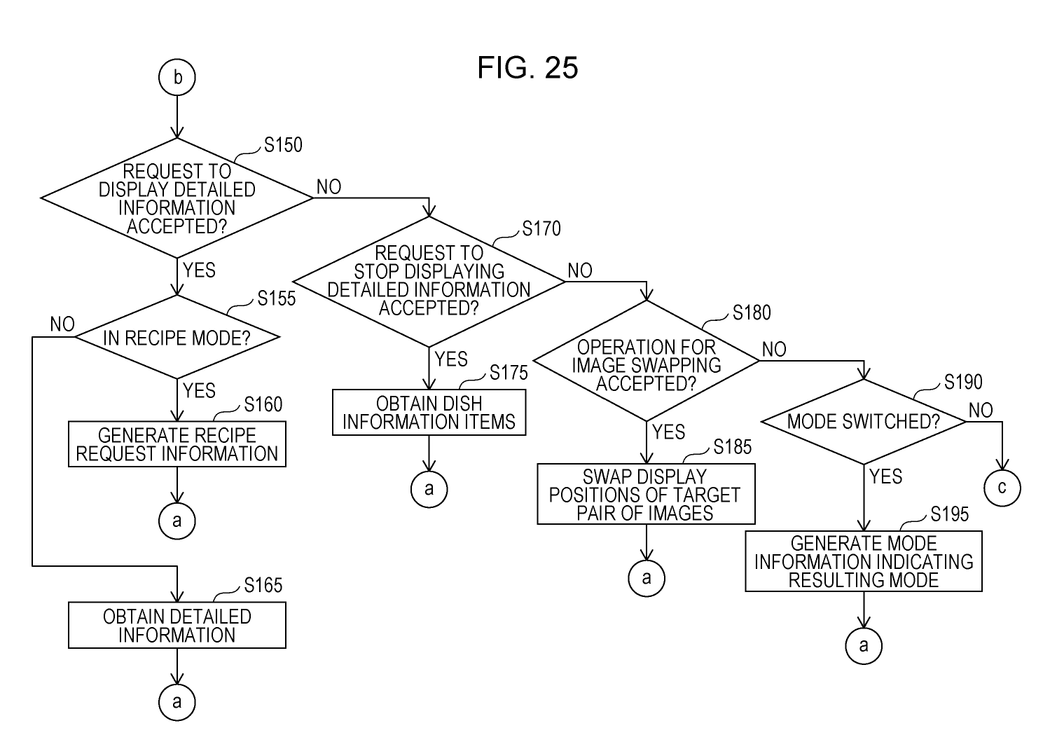

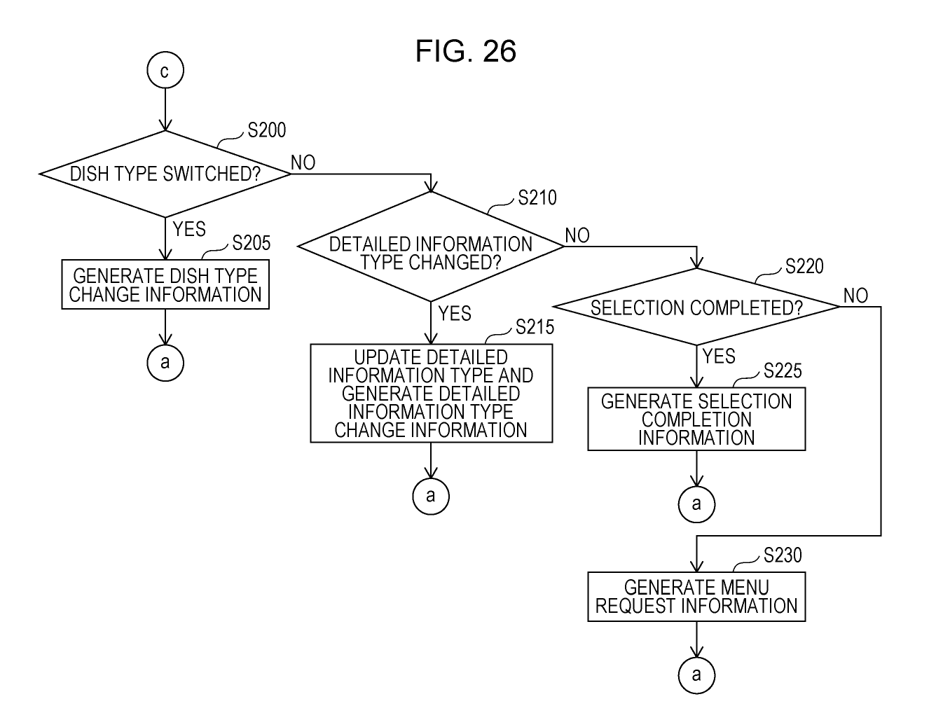

Referring now to flowcharts of FIGS. 24 to 26, an operation of the terminal-side event processing process of step S10 of FIG. 23 will be described.

The event identifying unit 311 of the mobile terminal 102 determines whether or not a menu request has been accepted from the user (step S100). For example, in the case where the user has started an application to receive dish information items provided by the server 101, the event identifying unit 311 determines that a menu request has been accepted.

If the event identifying unit 311 determines that a menu request has been accepted (“YES” in step S100), the information generating unit 312 generates menu request information (step S105). For example, the information generating unit 312 accepts the user ID, the mode, the meal type, the dish type, the detailed type, and the period from the user; and generates menu request information containing the accepted contents. The information generating unit 312 also stores the accepted mode, meal type, dish type, detailed type, and period in the dish information table T500. The information generating unit 312 also stores the user ID accepted from the user in a predetermined storage area.

Upon determining that a menu request has not been accepted (“NO” in step S100), the event identifying unit 311 determines whether or not a double tap operation has been accepted (step S110).

If the event identifying unit 311 determines that a double tap operation has been accepted (“YES” in step S110), the updating unit 313 executes an updating process (described later) (step S115).

Upon determining that a double tap operation has not been accepted (“NO” in step S110), the event identifying unit 311 determining whether or not a flick operation has been accepted (step S120).

If the event identifying unit 311 determines that a flick operation has been accepted (“YES” in step S120), the information generating unit 312 generates selection confirmation information (step S125). Specifically, the information generating unit 312 obtains the user ID from the predetermined storage area and obtains a dish name associated with each day of the week and a selection flag associated with the dish name from the dish information table T500; and generates selection confirmation information containing these contents.

Upon determining that a flick operation has not been accepted (“NO” in step S120), the event identifying unit 311 determines whether or not a request to display energy values has been accepted (step S130). For example, the event identifying unit 311 determines that a request to display energy values has been accepted when the icon button G102 has been tapped.

If the event identifying unit 311 determines that a request to display energy values has been accepted (“YES” in step S130), the information obtaining unit 314 obtains an energy value corresponding to each display-target dish from the dish information table T500 (step S135). Specifically, the information obtaining unit 314 has an energy display flag indicating on/off of displaying of energy values. If the value of the energy display flag is “0”, the energy values are not displayed. If the value of the energy display flag is “1”, the energy values are displayed. If the event identifying unit 311 determines that a request to display energy values has been accepted when the value of the energy display flag is “0”, the information obtaining unit 314 updates the value of the energy display flag to “1”. If the event identifying unit 311 determines that a request to display energy values has been accepted when the value of the energy display flag is “1”, the information obtaining unit 314 updates the value of the energy display flag to “0”.

Upon determining that a request to display energy values has not been accepted (“NO” in step S130), the event identifying unit 311 determines whether or not a request to change the meal type has been accepted (step S140). For example, the event identifying unit 311 determines that a request to change the meal type has been accepted when the display area G101 has been tapped.

If the event identifying unit 311 determines that a request to change the meal type has been accepted (“YES” in step S140), the information generating unit 312 generates meal type change information (step S145). For example, the information generating unit 312 identifies the resulting meal type from the number of times the display area G101 has been tapped, the meal type stored in the dish information table T500, and the rule for changing the meal type; and generates meal type change information containing the identified meal type and the user ID. The information generating unit 312 also updates the meal type stored in the dish information table T500 to the resulting meal type.

Upon determining that a request to change the meal type has not been accepted (“NO” in step S104), the event identifying unit 311 determines whether or not a request to display the detailed information has been accepted (step S150). For example, the event identifying unit 311 determines that a request to display the detailed information has been accepted when one of the areas A1 to A7, that is, one of images of dishes displayed for respective days of the week, has been tapped. Specifically, a tapped image is identifiable by determining which rectangle, which is identified by the display start position and the display end position contained in the dish information table T500, the tapped position detected by the controller 308 belongs to.

If the event identifying unit 311 determines that a request to display the detailed information has been accepted (“YES” in step S150), the event identifying unit 311 further determines whether or not the detailed type stored in the dish information table T500 indicates “RECIPE” (step S155).

If the event identifying unit 311 determines that the detailed type indicates “RECIPE” (“YES” in step S155), the information generating unit 312 generates recipe request information (step S160). Specifically, the information generating unit 312 identifies an image displayed at the single tapped position detected by the controller 308, and obtains a dish name corresponding to the identified image. The information generating unit 312 then generates recipe request information containing the user ID and the obtained dish name.

If the event identifying unit 311 determines that the detailed type does not indicate “RECIPE”, that is, the detailed type indicates “MENU” (“NO” in step S155), the information obtaining unit 314 obtains the detailed information from the dish information table T500 (step S165). Specifically, the information obtaining unit 314 identifies an image displayed at the single tapped position detected by the controller 308, and obtains the detailed information (i.e., a dish name, an energy value, and an image) corresponding to the identified image from the dish information table T500.

Upon determining that a request to display the detailed information has not been accepted (“NO” in step S150), the event identifying unit 311 determines whether or not a request to stop displaying the detailed information has been accepted (step S170).

If the event identifying unit 311 determines that a request to stop displaying the detailed information has been accepted (“YES” in step S170), the information obtaining unit 314 obtains images of dishes contained in respective dish information items associated with respective days of the week from the dish information table T500 (step S175).

Upon determining that a request to stop displaying of the detailed information has not been accepted (“NO” in step S170), the event identifying unit 311 determines whether or not an image swapping operation has been accepted (step S180).

If the event identifying unit 311 determines that an image swapping operation has been accepted (“YES” in step S180), the display position swapping unit 315 swaps the display positions of a target image and another target image (step S185). Specifically, the display position swapping unit 315 identifies the start and end positions of a swipe operation based on the detection results regarding positions touched with a finger or the like obtained by the controller 308, and identifies images displayed at the start position and the end position. The display position swapping unit 315 swaps a record including the dish name, the energy value, and the image associated with the identified image and a record including the dish name, the energy value, and the image associated with the other identified image in the dish information table T500.

Upon determining that an image swapping operation has not been accepted (“NO” in step S180), the event identifying unit 311 determines whether or not the mode has been switched (step S190). Specifically, the event identifying unit 311 determines that the mode has been switched when the button G103 is tapped.

If the event identifying unit 311 determines that the mode has been switched (“YES” in step S190), the information generating unit 312 generates mode information (step S195). Specifically, when the button G103 is tapped, the information generating unit 312 identifies the resulting mode on the basis of the mode stored in the dish information table T500, and generates mode information containing the identified mode and the user ID. The information generating unit 312 also updates the mode stored in the dish information table T500 to the resulting mode.

Upon determining that the mode has not been switched (“NO” in step S190), the event identifying unit 311 determines whether or not the dish type has been switched (step S200). For example, the event identifying unit 311 determines that the dish type has been switched when the button G104 is tapped.

If the event identifying unit 311 determines that the dish type has been switched (“YES” in step S200), the information generating unit 312 generates dish type change information (step S205). Specifically, when the button G104 is tapped, the information generating unit 312 identifies the resulting dish type based on the dish type stored in the dish information table T500, and generates dish type change information containing the identified dish type and the user ID. The information generating unit 312 also updates the dish type stored in the dish information table T500 to the resulting dish type.

Upon determining that the dish type has not been switched (“NO” in step S200), the event identifying unit 311 determines whether or not the detailed type has been switched (step S210). For example, when the button G105 is tapped, the event identifying unit 311 determines that the detailed type has been switched.

If the event identifying unit 311 determines that the detailed type has been switched (“YES” in step S210), the information generating unit 312 generates detailed type change information (step S215). Specifically, when the button G105 is tapped, the information generating unit 312 identifies the resulting detailed type based on the detailed type stored in the dish information table T500, and generates detailed type change information containing the identified detailed type and the user ID. The information generating unit 312 updates the detailed type stored in the dish information table T500 to the resulting detailed type.

Upon determining that the detailed type has not been switched (“NO” in step S210), the event identifying unit 311 determines whether or not an operation indicating completion of selection for everyday of the week has been accepted (step S220). For example, when the button G150 is tapped on the screen G100h illustrated in FIG. 15, the event identifying unit 311 determines that an operation indicating completion of selection has been accepted. In addition, when the button G151 is tapped, the event identifying unit 311 determines that an operation indicating that selection has not been completed has been accepted.

If the event identifying unit 311 determines that an operation indicating completion of selection has been accepted (“YES” in step S220), the information generating unit 312 generates selection completion information (step S225).

If the event identifying unit 311 determines that an operation indicating completion of selection has not accepted, that is, an operation indicating that selection is not completed has been accepted (“NO” in step S220), the information generating unit 312 generates menu request information (step S230).

The menu request information, the selection confirmation information, the meal type change information, the recipe request information, the mode information, the dish type change information, the detailed type change information, and the selection completion information generated through the terminal-side event processing process serve as information to be transmitted to the server 101, and are transmitted to the server 101 in step S20 in FIG. 23.

### 3) Updating Process

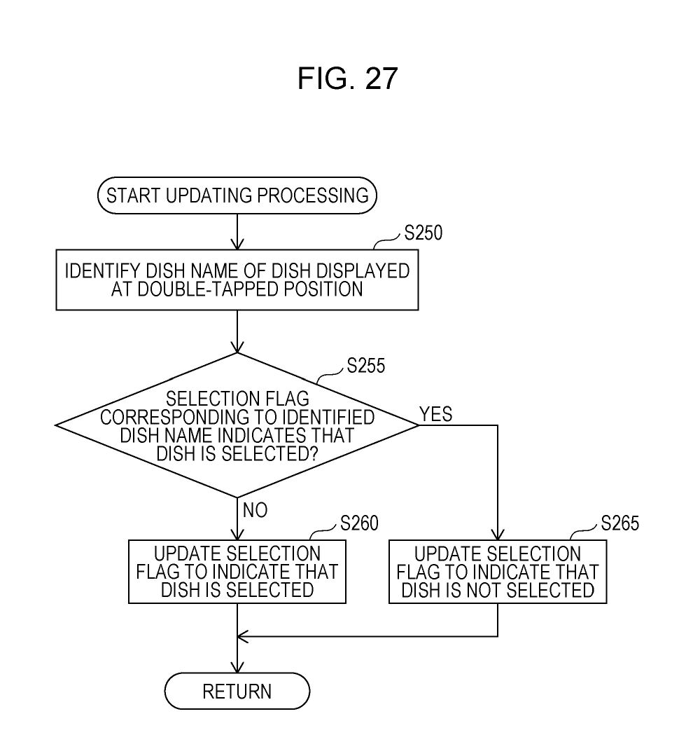

Referring now to a flowchart of FIG. 27, the updating process of step S115 of FIG. 24 will be described.

The updating unit 313 identifies, by using the dish information table T500, a dish name corresponding to an image of a dish displayed at the double tapped position detected by the controller 308 (step S250).

The updating unit 313 determines whether or not the value of the selection flag associated with the identified dish name is “1”, that is, whether or not the identified dish name is selected (step S255).

Upon determining that the value of the selection flag associated with the identified dish name is not “1”, that is, the value is “0” (“NO” in step S255), the updating unit 313 updates the value of the selection flag associated with the identified dish name to “1” so that the selection flag of the identified dish name indicates “SELECTED” (step S260).

Upon determining that the value of the selection flag associated with the identified dish name is “1” (“YES” in step S255), the updating unit 313 updates the value of the selection flag associated with the identified dish name to “0” so that the selection flag of the identified dish name indicates “NOT SELECTED” (step S260).

### 4) Server-Side Event Processing Process

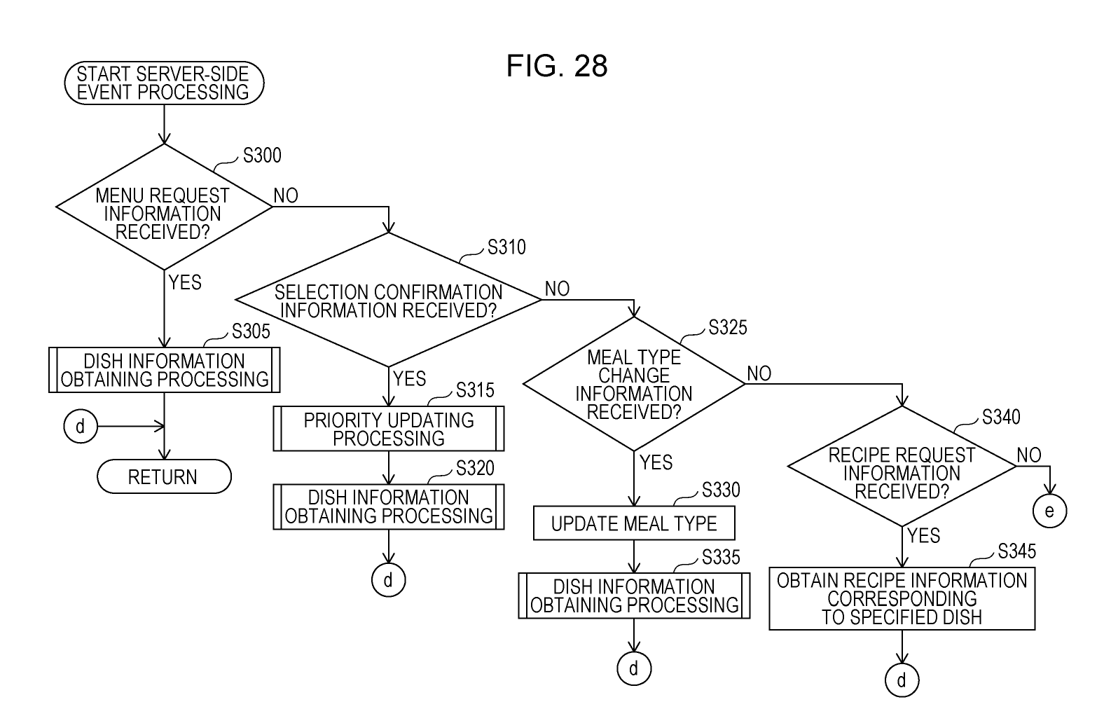

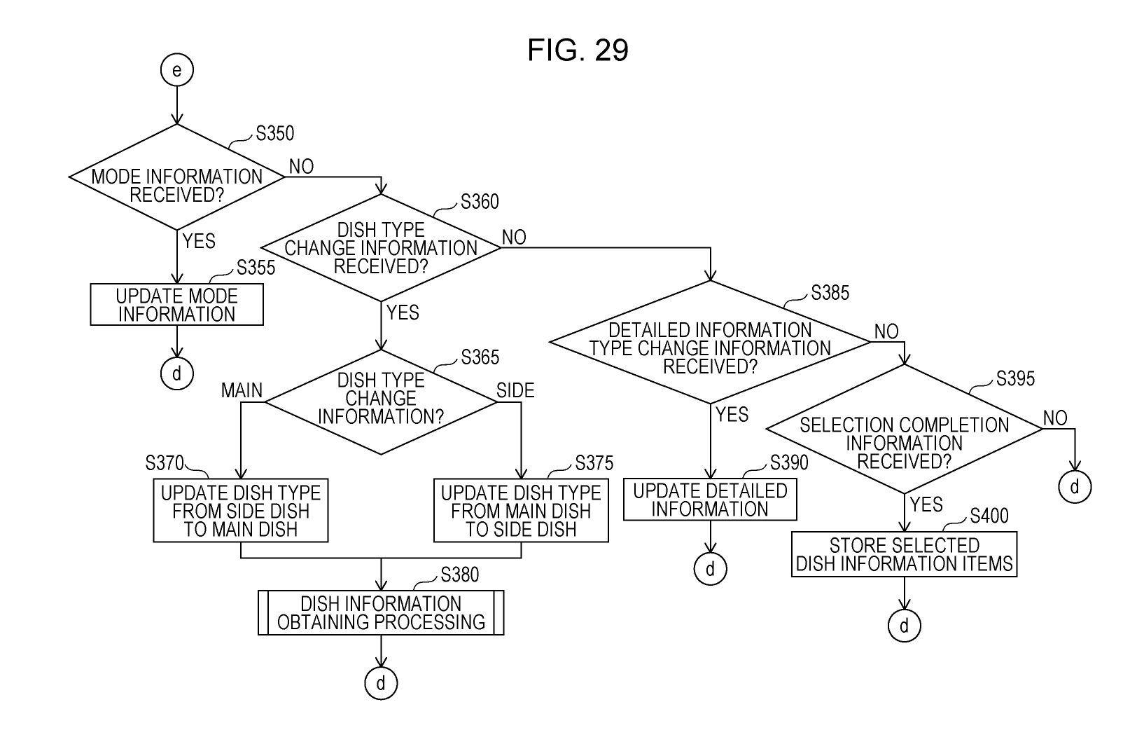

Referring now to flowcharts of FIGS. 28 and 29, the server-side event processing process in step S25 of FIG. 23 will be described.

The event sorting unit 221 determines whether or not menu request information has been received from the mobile terminal 102 (step S300).

If the event sorting unit 221 determines that menu request information has been received (“YES” in step S300), the dish information obtaining unit 222 performs a dish information obtaining process (step S305).

Upon determining that menu request information has not been received (“NO” in step S300), the event sorting unit 221 determines whether or not selection confirmation information has been received (step S310).

If the event sorting unit 221 determines that selection confirmation information has been received (“YES” in step S310), the priority changing unit 223 performs a priority changing process (step S315). Then, the dish information obtaining unit 222 performs a dish information obtaining process (step S320).

Upon determining that selection confirmation information has not been received (“NO” in step S310), the event sorting unit 221 determines whether or not meal type change information has been received (step S325).

If the event sorting unit 221 determines that meal type change information has been received (“YES” in step S325), the dish information obtaining unit 222 updates the meal type associated with the same user ID as the user ID contained in the received meal type change information in the provided dish information table T400 to the meal type contained in the meal type change information (step S330), and then performs a dish information obtaining process (step S335).

Upon determining that meal type change information has not been received (“NO” in step S325), the event sorting unit 221 determines whether or not recipe request information has been received (step S340).

If the event sorting unit 221 determines that recipe request information has been received (“YES” in step S340), the recipe obtaining unit 225 obtains recipe information associated with the dish name contained in the received recipe request information from the recipe information table T200 (step S345).

Upon determining that recipe request information has not been received (“NO” in step S340), the event sorting unit 221 determines whether or not mode information has been received (step S350).

If the event sorting unit 221 determines that mode information has been received (“YES” in step S350), the updating unit 224 updates the mode associated with the same user ID as the user ID contained in the received mode information in the provided dish information table T400 to the mode contained in the mode information (step S355).

Upon determining that the mode information has not been received (“NO” in step S350), the event sorting unit 221 determines whether or not dish type change information has been received (step S360).

If the event sorting unit 221 determines that dish type change information has been received (“YES” in step S360), the dish information obtaining unit 222 determines whether the dish type contained in the received dish type change information indicates the main dish or the side dish (step S365).

If the dish information obtaining unit 222 determines that the dish type indicates the main dish (“MAIN” in step S365), the dish information obtaining unit 222 updates the content of the dish type field associated with the same user ID as the user ID contained in the received dish type change information from the side dish to the main dish in the provided dish information table T400 (step S370).

If the dish information obtaining unit 222 determines that the dish type indicates the side dish (“SIDE” in step S365), the dish information obtaining unit 222 updates the content of the dish type field associated with the same user ID as the user ID contained in the received dish type change information from the main dish to the side dish in the provided dish information table T400 (step S375).

Then, the dish information obtaining unit 222 performs a dish information obtaining process (step S380).

Upon determining that dish type change information has not been received (“NO” in step S360), the event sorting unit 221 determines whether or not detailed type change information has been received (step S385).

If the event sorting unit 221 determines that the detailed type change information has been received (“YES” in step S385), the updating unit 224 updates the detailed type associated with the same user ID as the user ID contained in the received detailed type change information in the provided dish information table T400 to the detailed type contained in the detailed type change information (step S390).

Upon determining that the detailed type change information has not been received (“NO” in step S385), the event sorting unit 221 determines whether or not selection completion information has been received (step S395).

If the event sorting unit 221 determines that selection completion information has been received (“YES” in step S395), the updating unit 224 obtains transmission/reception information containing the user ID contained in the selection completion information from the provided dish information table T400, and stores the obtained transmission/reception information in a predetermined area of the storage unit 204 (step S400).

The dish information and the recipe information obtained through the server-side event processing process serve as information to be transmitted to the mobile terminal 102, and are transmitted to the mobile terminal 102 in step S35 of FIG. 23.

### 5) Dish Information Obtaining Process

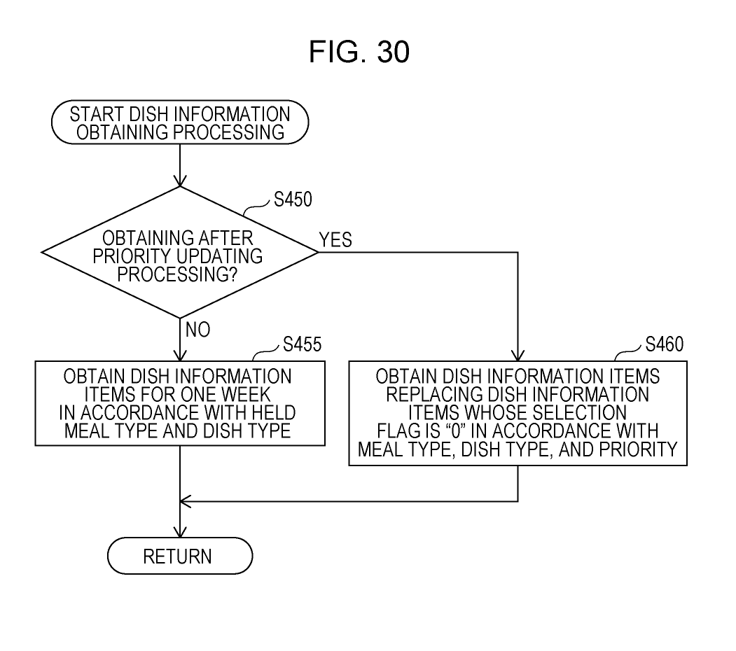

Referring now to a flowchart of FIG. 30, the dish information obtaining process performed in the server-side event processing process will be described.

The dish information obtaining unit 222 determines whether or not this dish information obtaining process is subsequent to the priority changing process (described later) (step S450). Specifically, the dish information obtaining unit 222 determines that this dish information obtaining process is subsequent to a priority changing process if it has received an instruction to obtain a dish information item from the priority changing unit 223.

If the dish information obtaining unit 222 determines that this dish information obtaining process is not subsequent to the priority changing process (“NO” in step S450), the dish information obtaining unit 222 obtains dish information items for one week in accordance with the meal type and the dish type associated with the requesting user in the provided dish information table T400 (step S455). For example, the dish information obtaining unit 222 obtains a dish information item for each day of the week (e.g., in the order of Monday, Tuesday, . . . , Saturday, and Sunday), thereby being able to obtain dish information items for respective days of the week.

If the dish information obtaining unit 222 determines that this dish information obtaining process is subsequent to the priority changing process (“YES” in step S450), the dish information obtaining unit 222 obtains a dish information item whose selection flag value is “0”, that is, an alternative dish information item for the dish information item not selected by the user, in accordance with the meal type and the dish type associated with the requesting user in the provided dish information table T400 and the priority associated with the requesting user in the dish information database T100 (step S460). For example, the dish information obtaining unit 222 obtains at random as many dish information items as the number of dish information items not selected by the user from dish information items that are associated with the meal type and the dish type associated with the requesting user and that have the highest priority. At this time, in the case there are not as many dish information items that are associated with the meal type and the dish type associated with the requesting user and that has the highest priority as the number of dish information items not selected by the user, the dish information obtaining unit 222 obtains at random as many dish information items as the number of dish information items not selected by the user from among dish information items having the highest priority and dish information items having the second highest priority. That is, in the case where the total number of dish information items having the highest priority to the n-th (n is a natural number) highest priority is smaller than the number of dish information items not selected by the user, the dish information obtaining unit 222 obtains at random as many dish information items as the number of dish information items not selected by the user from among dish information items having the highest priority to the (n+1)-th highest priority.

### 6) Priority Changing Process

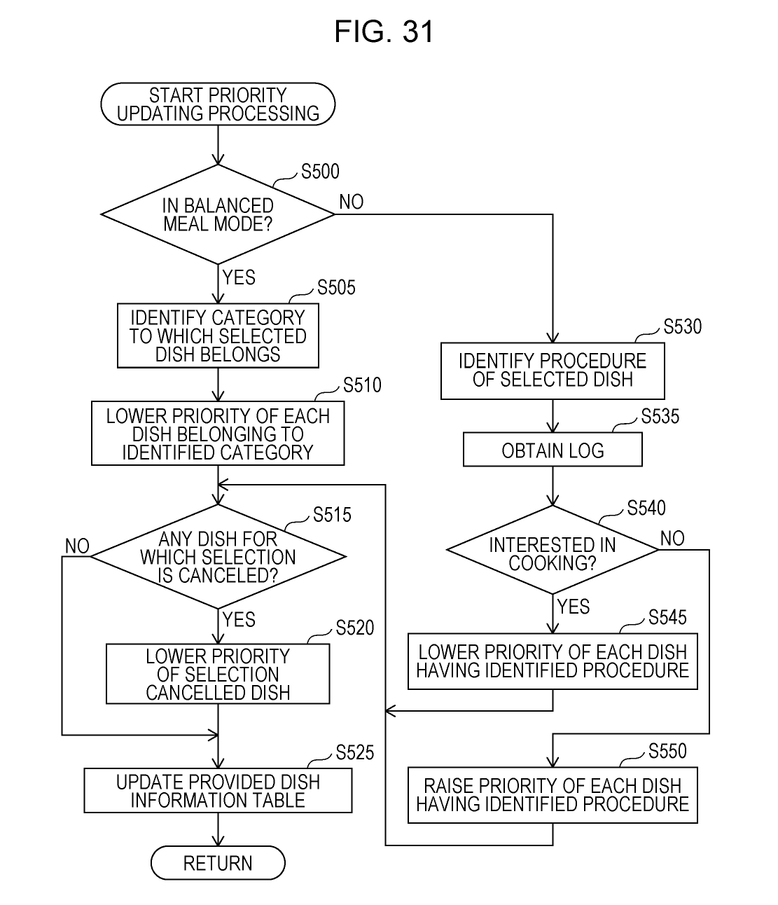

Referring now to a flowchart of FIG. 31, the priority changing process performed in the server-side event processing process will be described.

The priority changing unit 223 determines whether or not the mode associated with the same user ID as the user ID contained in the selection confirmation information in the provided dish information table T400 is the balanced meal mode (step S500).

If the priority changing unit 223 determines that the mode is the balanced meal mode (“YES” in step S500), the priority changing unit 223 identifies the category of each dish currently selected by the user (step S505). For example, the priority changing unit 223 identifies, by using the received selection confirmation information, all categories associated with dish information items whose selection flag value is “1” among dish information items associated with the user who has transmitted the selection confirmation information.

The priority changing unit 223 changes the priority of each dish assigned to the user who has transmitted the selection confirmation information so as to make the priority of each dish information item associated with any of the identified categories lower than the priority of each dish information item not associated with any of the identified categories (step S510).

The priority changing unit 223 determines whether or not there is a deselected dish (step S515). For example, the priority changing unit 223 determines that the selected state has been canceled if the selection flag value for the dish name contained in the transmission/reception information associated in the provided dish information table T400 with the user who has transmitted the selection confirmation information is “1” but the selection flag value for the same dish name contained in the received selection confirmation information is “0”.

If the priority changing unit 223 determines that there is a deselected dish (“YES” in step S515), the priority changing unit 223 lowers the priority of the deselected dish (step S520). Specifically, the priority changing unit 223 changes the priority of the deselected dish so as to make the priority of the deselected dish lower than the priority of each dish that has been changed in step S510 or S545.

Subsequently to step S520 or if the priority changing unit 223 determines that there is no deselected dish (“NO” in step S515), the priority changing unit 223 updates the value of each selection flag contained in the transmission/reception information associated with the user who has transmitted the selection confirmation information to the value of the selection flag contained in the received selection confirmation information (step S525).

If the priority changing unit 223 determines that the mode is not the balanced meal mode, that is, the mode is the cooking interest mode (“NO” in step S500), the priority changing unit 223 identifies a procedure of each dish currently selected by the user (step S530).

The priority changing unit 223 obtains log information regarding the user who has transmitted the selection confirmation information from the log information table T300 (step S535).

The priority changing unit 223 determines whether or not the user is interested in cooking by using the obtained log information (step S540). For example, the priority changing unit 223 determines that the user is interested in cooking if a log information updating frequency is high. For example, the log information updating frequency being high is the log information being updated a predetermined number of times (e.g., five times) or more per day. The log information updating frequency being low is the log information being updated less than the predetermined number of times (e.g., five times) per day.

If the priority changing unit 223 determines that the user is interested in cooking (“YES” in step S540), the priority changing unit 223 changes the priority of each dish assigned to the user who has transmitted the selection confirmation information so as to make the priority of each dish information item associated with any of the identified procedures lower than the priority of each dish information item not associated with any of the identified procedures (step S545).

If the priority changing unit 223 determines that the user is not interested in cooking (“NO” in step S540), the priority changing unit 223 changes the priority of each dish assigned to the user who has transmitted the selection confirmation information so as to make the priority of each dish information item associated with any of the identified procedures higher than the priority of each dish information item not associated with any of the identified procedures (step S550).

After the priority changing unit 223 has performed step S545 or S550, the process proceeds to step S515.

### 7) Display Process

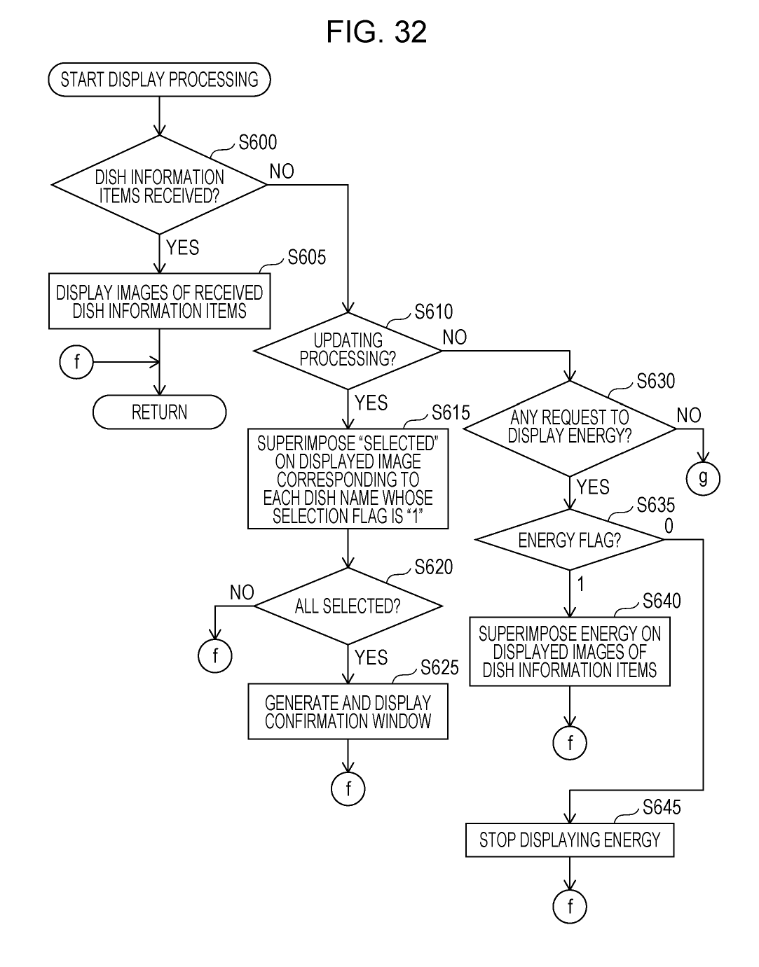

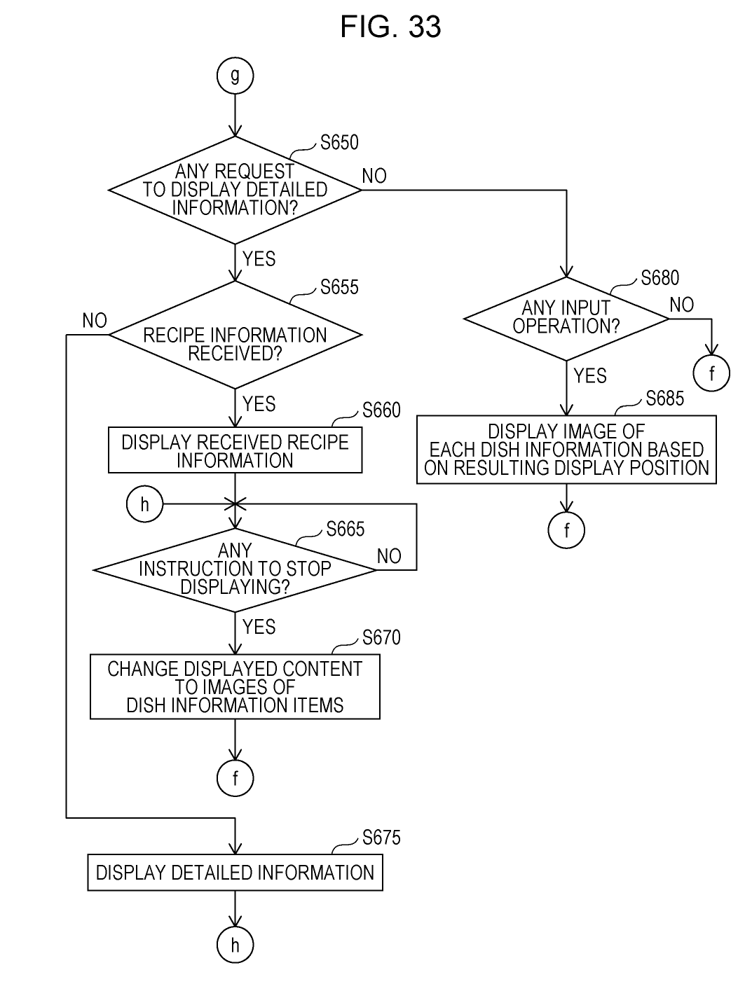

Referring now to flowcharts of FIGS. 32 and 33, the display process performed in step S40 of FIG. 24 will be described.

The display processing unit 316 determines whether or not dish information items for one week have been received from the server 101 (step S600).

If the display processing unit 316 determines that the dish information items have been received (“YES” in step S600), the display processing unit 316 displays images represented by image data items contained in the received dish information items (step S605). Specifically, the display processing unit 316 displays images represented by image data items contained in the received dish information items on the basis of the screen layout illustrated in FIG. 10.

The display processing unit 316 determines whether or not the updating process has been performed by the updating unit 313 (step S610). Specifically, the display processing unit 316 determines that the updating process has been performed if the display processing unit 316 has received an instruction to start performing the display process from the updating unit 313.

If the display processing unit 316 determines that the updating process has been performed (“YES” in step S610), the display processing unit 316 superimposes a character string “SELECTED” on the displayed image corresponding to each dish name whose selection flag value is “1” (step S615). The display processing unit 316 determines whether or not all dishes have been selected (step S620).

If the display processing unit 316 determines that all dishes have been selected (“YES” in step S620), the display processing unit 316 generates and displays the confirmation screen (step S625).

Upon determining that the updating process has not been performed (“NO” in step S610), the display processing unit 316 determines whether or not a request to display energy values has been made (step S630).

If the display processing unit 316 determines that a request to display energy values has been made (“YES” in step S630), the display processing unit 316 further determines the value of the energy display flag (step S635).

If the value of the energy display flag is “1” (“1” in step S635), the display processing unit 316 superimposes an energy value of each dish obtained by the information obtaining unit 314 on the corresponding image (step S640).

If the value of the energy display flag is “0” (“0” in step S635), the display processing unit 316 hides an energy value of each dish obtained by the information obtaining unit 314 (step S645).

Upon determining that a request to display energy values has not been made (“NO” in step S630), the display processing unit 316 determines whether or not a request to display detailed information has been made (step S650).

If the display processing unit 316 determines that a request to display detailed information has been made (“YES” in step S650), the display processing unit 316 determines whether or not recipe information has been received (step S655).

If the display processing unit 316 determines that recipe information has been received (“YES” in step S655), the display processing unit 316 displays the received recipe information and an image corresponding to a dish name contained in the recipe information (step S660).

The display processing unit 316 displays the recipe information until an instruction to stop displaying the recipe information is accepted. Upon receipt of an instruction to stop displaying, the display processing unit 316 displays images of individual dish information items contained in the dish information table T500 (steps S665 or S670).

If the display processing unit 316 determines that recipe information has not been received (“NO” in step S655), the display processing unit 316 displays detailed information obtained by the information obtaining unit 314 (step S675).

Upon determining that a request to display detailed information has not been made (“NO” in step S650), the display processing unit 316 determines whether or not an image swapping operation has been performed (step S680).

If the display processing unit 316 determines that an image swapping operation has been performed (“YES” in step S680), the display processing unit 316 displays images contained in the dish information items by using the dish information table T500 on which the operation for swapping display positions has been performed (step S685).

### 8) Specific Example of Operation

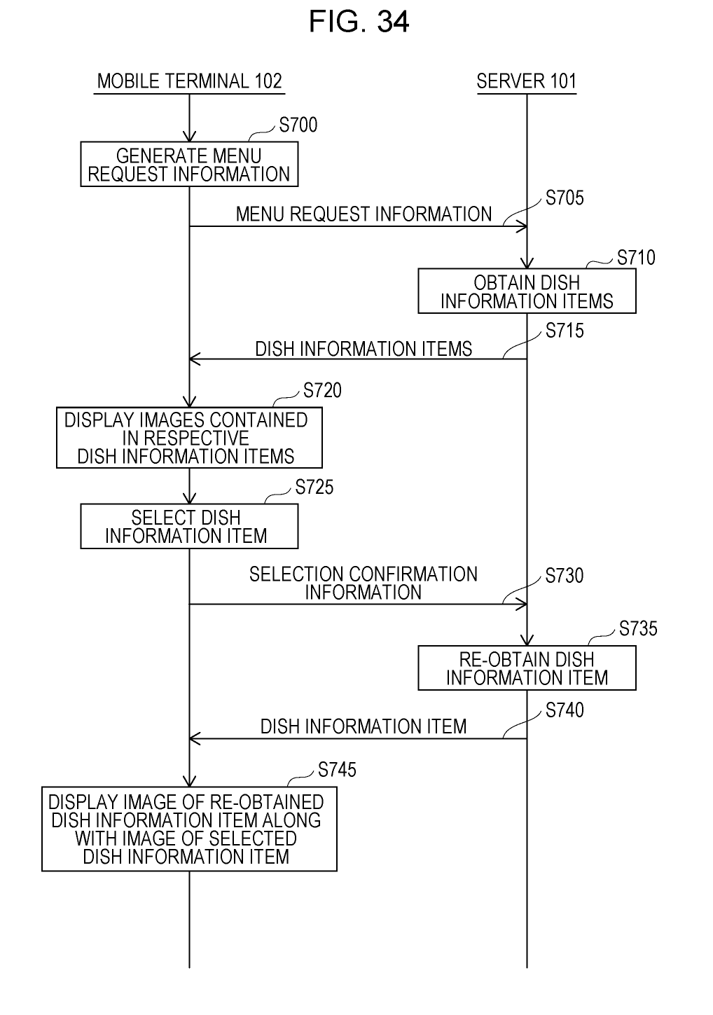

Referring now to a flowchart of FIG. 34, an operation for displaying a menu will be described as a specific example of the operation performed by the dish information providing system 100.

Upon receipt of an instruction to request a menu through a user operation, the mobile terminal 102 generates menu request information (step S700).

The mobile terminal 102 transmits the generated menu request information to the server 101 (step S705).

Upon receipt of the menu request information from the mobile terminal 102, the server 101 obtains dish information items for one week in accordance with contents of the received menu request information (step S710). Then, the server 101 transmits the obtained dish information items to the mobile terminal 102 (step S715).

The mobile terminal 102 displays images contained in the received dish information items (step S720).

The user performs a selection candidate accepting operation (double tap selection operation) on the dish information items provided by the server 101 (step S725).

When the user performs a flick operation, the mobile terminal 102 generates selection confirmation information, and transmits the generated selection confirmation information to the server 101 (step S730).

Upon receipt of the selection confirmation information from the mobile terminal 102, the server 101 performs the priority changing process, and obtains, by using the priority that has been changed, an alternative dish information item for an dish information item not selected by the user (step S735). Then, the server 101 transmits the obtained dish information item to the mobile terminal 102 (step S740).

The mobile terminal 102 displays an image contained in the dish information item re-obtained in step S740 along with the images contained the selected dish information items (step S745).

### 1.6 Exemplary Modifications

While the description has been given based on the embodiment above, the present disclosure is not limited to the above-described embodiment. For example, following modifications are conceivable.

(1) In the above-described embodiment, the dish information providing system 100 changes the priority of each dish by using the categories associated with the respective dishes in the case where the mode is the balanced meal mode; however, the configuration is not limited to this one.

The dish information providing system 100 may change the priority of each dish by using the techniques associated with the respective dishes. This configuration allows dish information items to be provided without inclination to only one technique.

For example, in the case where the mode is the “balanced meal mode”, the priority changing unit 223 of the server 101 changes the priority of each dish assigned to the user indicated by the user ID contained in the selection confirmation information received from the mobile terminal 102 so as to make the priority for a dish name associated with the same technique as the technique associated with a dish name whose selection flag value is “1” among dish names contained in the selection confirmation information lower than the priority for a dish name associated with any other technique.

(2) In the dish information database T100 described in the above-described embodiment, each dish name may be associated with information (hereinafter, referred to as country information) indicating a country of the dish, such as Japanese food, French food, and Italian food.

This configuration allows the dish information providing system 100 to provide dish information items of dishes of a wide variety of countries without inclination to dishes of only one country.

For example, in the case where the mode is the “balanced meal mode”, the priority changing unit 223 of the server changes the priority of each dish assigned to the user indicated by the user ID contained in the selection confirmation information received from the mobile terminal 102 so as to make the priority for a dish name associated with the same country information as country information associated with a dish name whose selection flag value is “1” among individual dish names contained in the selection confirmation information lower than the priority of a dish name associated with other country information.

(3) In the above-described embodiment, in the case where the user accepts all dish information items provided by the server 101, the server 101 may change the priorities of the provided dish information items that have been accepted.

This configuration allows the server 101 to provide the user with dish information items for the following week on the basis of the priorities that have been changed in the case where the user is provided with dish information items for the following week without tapping the button G106 after the user has accepted the provided dish information items for a given week.

For example, in the case where the user is provided with dish information items for the following week without tapping the button G106 after the user has accepted provided dish information items for a given week, the server 101 changes the priority of each dish assigned to the user indicated by the user ID contained in the selection confirmation information received from the mobile terminal 102 so as to make the priority for a dish name whose selection flag value is “1” among individual dish names contained in the selection confirmation information lower than the priority for other dish names. This configuration allows the dish information providing system 100 to preferentially provide dish information items for the following week that indicate dishes other than those that have been accepted by the user.

(4) In the above-described embodiment, in the case where the user is provided with dish information items for the following week without tapping the button G106 after the user has accepted provided dish information items for a given week, the server 101 may provide dish information items for the following week on the basis of the provided dish information items that have been accepted.

For example, the server 101 provides, for Monday of the following week, a dish associated with the same category as the category of a dish accepted for Monday of a given week for which provided dish information items have been accepted. That is, the server 101 provides, for the same day of the following week, a dish information item associated with the same category as the category of a provided dish information item accepted for a given day of the week.

This configuration allows the dish information providing system 100 to change the categories on a regular basis by providing a dish information item of the same category for the same day of the week.

(5) In the above-described embodiment, the dish information providing system 100 changes the priority of a dish by using the log information of the microwave oven 103 and the induction cooktop 104 in the case where the mode is the cooking interest mode; however, the configuration is not limited to this one.

The server 101 of the dish information providing system 100 may store information (hereinafter, referred to as preference information) indicating the user's preference regarding a procedure and may change the priority of each dish on the basis of the preference information.

This configuration allows the dish information providing system 100 to provide dish information items based on the user's preference for dishes.

For example, in the case where a procedure indicated by the preference information matches a procedure associated with a dish name whose selection flag information is “1” among individual dish names contained in selection confirmation information received from the mobile terminal 102, the priority changing unit 223 of the server 101 changes the priority of each dish assigned to the user indicated by the user ID contained in the selection confirmation information so as to make the priority of a dish name associated with the procedure indicated by the preference information higher than the priority of a dish name associated with another procedure.

In addition, in the case where a procedure indicated by the preference information does not match a procedure associated with a dish name whose selection flag value is “1” among individual dish names contained in the selection confirmation information received from the mobile terminal 120, the priority changing unit 223 of the server 101 changes the priority of each dish assigned to the user indicated by the user ID contained in the selection confirmation information so as to make the priority of a dish name associated with the same procedure as the procedure associated with a dish name whose selection flag value is “1” lower than the priority of a dish name associated with another procedure.

(6) In the above-described embodiment, energy values of dishes indicated by the provided dish information items are displayed upon the icon button G102 being tapped; however, the configuration is not limited to this one.

Information to be displayed is not limited to energy values and may be any information representing a nutritional value such as salt intake or vitamin intake.

This configuration allows the dish information providing system 100 to notify the user of nutritional values of a variety of dishes to be provided.

(7) In the above-described embodiment, when displaying energy values, the mobile terminal 102 may display energy values of accepted dishes provided by the server 101 and energy values of unaccepted dishes in different colors.

This configuration allows the user to distinguish at a glance nutritional values of accepted dishes provided by the server 101 from nutritional values of unaccepted dishes.

(8) In the above-described embodiment, the updating process, obtaining of energy information, obtaining of detailed information, and swapping of display positions are performed by the mobile terminal 102; however, the configuration is not limited to this one.

All or some of these processes may be performed by the server 101. This configuration can reduce a processing load of the mobile terminal 102.

For example, information is updated by the server 101 in the following manner. Instead of the provided dish information table T400, the server 101 stores the dish information table T500 that is originally stored in the mobile terminal 102 in the above-described embodiment. The mobile terminal 102 transmits operation information indicating that a double tap has been performed and position information indicating a position double tapped by the user to the server 101. If the event sorting unit 221 determines that operation information indicating that a double tap has been preformed has been received, the server 101 identifies an image of a dish displayed at the double tapped position by using the received position information and the dish information table T500. The server 101 superimposes a character string “SELECTED” on the identified image of the dish, and transmits the image of the dish on which the character string “SELECTED” is superimposed to the mobile terminal 102. The mobile terminal 102 displays the received image of the dish on which the character string “SELECTED” is superimposed instead of the double tapped image of the dish.

By the mobile terminal 102 transmitting information (operation information) indicating content of an operation performed by the user and information indicating a position where the operation (such as a double tap) has been performed to the server 101, the server 101 can perform a process in accordance with the operation information and the position where the operation has been performed. This configuration allows the server 101 to perform, in place of the mobile terminal 102, a process performed by the mobile terminal 102 in the above-described embodiment.

(9) The mobile terminal 102 may perform, in place of the server 101, a process performed by the server 101 in the above-described embodiment.

This configuration can reduce a processing load of the server 101.

For example, the mobile terminal 102 receives the dish information database T100 from the server 101 when a process is started. In this way, the mobile terminal 102 can perform various processes originally performed by the server 101.

(10) In the above-described embodiment, the recipe information indicates a recipe for one serving; however, the configuration is not limited to this one.

The recipe information may indicate a recipe for two or more servings.

Alternatively, a recipe of a dish for one serving may be initially displayed as the recipe information, and thereafter the number of servings may be changed to another value through a user operation.

This configuration allows a dish recipe based on the number of family members, for example, to be provided.

For example, the server 101 stores, for each dish, recipe information for each number of servings. In this case, in response to a scroll operation performed by the user when recipe information of a certain dish for one serving is displayed on the mobile terminal 102, the displayed recipe information is changed to recipe information for another number of servings. Specifically, if the user performs a scroll operation toward the top of the screen, the number of servings is increased in accordance with the amount of scroll (e.g., a moved distance of a touch). The mobile terminal 102 obtains and displays recipe information for the number of servings that has been increased from the server 101. In addition, if the user performs a scroll operation toward the bottom of the screen, the number of servings is decreased in accordance with the amount of scroll (e.g., a moved distance of a touch). The mobile terminal 102 obtains and displays recipe information for the number of servings that has been decreased from the server 101.

Note that the upper limit is set, for example, to 10. The number of servings is not to be changed if a scroll operation is performed toward the top of the screen when the number of servings is 10. In addition, the lower limit is set to 1. The number of servings is not to be changed if a scroll operation is performed toward the bottom of the screen when the number of servings is 1.

Further, not only the number of servings but also taste, energy, salt intake, or the like preferred by the user may be changed through a scroll operation.

This configuration allows the dish information providing system 100 to provide each user with dish information items based on the user's preference even for the same dish.

(11) In the above-described embodiment, the dish information providing system 100 provides a dish information item for each day of a specified period (one week); however, the configuration is not limited to this one.

The user can set a day to eat out within the specified period, and the server 101 need not provide a dish information item for the day to eat out. With this configuration, the dish information providing system 100 need not provide a meal plan for a day to eat out. That is, this configuration can prevent a dish information item from being provided unnecessarily.

Alternatively, the dish information providing system 100 may be configured to recommend a restaurant located near the user's home or office or along a commutation route for a day to eat out. This configuration allows the dish information providing system 100 to recommend a restaurant at which the user eats out by taking into account nutrient balance over the predetermined period, for example.

For example, recommendation of a restaurant is implemented in the following manner. The server 101 stores, for each restaurant, the name of the restaurant, a main category of dishes served by the restaurant, and the address of the restaurant in association with one another. When the user sets a day to eat out, the mobile terminal 102 accepts the user's home address, the user's office address, and the commutation route from the user; and transmits the accepted information to the server 101. The server 101 transmits, to the mobile terminal 102, the name and address of a restaurant that serves dishes of a different category from categories of dishes indicated by dish information items provided for the days for which eating out is not set and that is located near the user's home or office or along the commutation route. The mobile terminal 102 displays the name and address of the restaurant received from the server 101 in a display area corresponding to the day for which eating out is set.

(12) In the above-described embodiment, the balanced meal mode or the cooking interest mode is set as the mode for providing dish information items in the dish information providing system 100; however, the settable modes are not limited to these modes.

Other modes may be set. This configuration allows the dish information providing system 100 to provide dish information items from a viewpoint different from the balance of meals or whether or not the user is interested in cooking.

For example, the dish information providing system 100 may provide a dish information item of a dish that uses an ingredient that was used a week before or a few days before. Specifically, when providing a dish information item for Monday, the dish information providing system 100 provides an dish information item of a dish that uses an ingredient (e.g., carrot) used in a dish indicated by a dish information item provided for a day before (i.e., Sunday) or a week before.

With this configuration, the dish information providing system 100 allows the user to efficiently use a ingredient in the case where the ingredient used a week before or a few days before is left over.

(13) In the above-described embodiment, the dish information providing system 100 provides dish information items for a predetermined period on the assumption that the user cooks at home; however, the assumption is not limited to this one.

The dish information providing system 100 may provide a menu for each day of the week in the case where the user eats at a specific restaurant over a predetermined period.

This configuration allows the dish information providing system 100 to provide a menu by taking into account balance of meals even in the case where the user eats at a specific restaurant everyday.

(14) In the above-described embodiment, the dish information providing system 100 provides a dish information item for one of breakfast, lunch, dinner, and snack for each day of the week; however, the configuration is not limited to this one.

The dish information providing system 100 may provide dish information items for a plurality of meals from among breakfast, lunch, dinner, and snack for each day of the week.

This configuration allows the dish information providing system 100 to provide dish information items for three meals (i.e., breakfast, lunch, and dinner) for each day of the week, for example.

(15) In the above-described embodiment, the dish information providing system 100 provides dish information items of one dish type from among the main dish and the side dish; however, the configuration is not limited to this one.

The dish information providing system 100 may provide dish information items of both the dish types (i.e., the main dish and the side dish) for each day of the week.

This configuration allows the dish information providing system 100 to provide dish information items of both the main dish and the side dish by using a single screen.

(16) In the above-described embodiment, the dish information providing system 100 provides dish information items for one week; however, the configuration is not limited to this one.

The dish information providing system 100 may provide dish information items for a predetermined number of days.

The dish information providing system 100 can provide, for example, balanced meals over a predetermined number of days by providing dish information items for a plurality of days.

(17) In the above-described embodiment, images of dishes for all days of the week are changed to images of alternative dishes when the button G151 is tapped on the menu confirmation screen (see the screens G100h and G100j of FIG. 16); however, the configuration is not limited to this one.

In response to tapping of the button G151 on the menu confirmation screen, the character string “SELECTED” may be hidden for a dish of a lastly double tapped image.

(18) In the above-described embodiment, if an image of a dish displayed on the screen of the mobile terminal 102 is single tapped, the dish information providing system 100 changes the screen so that recipe information of the dish indicated by the image is displayed in the case where the detailed type is “RECIPE” (see FIG. 20); however, the configuration is not limited to this one.

In the case where the detailed type is “RECIPE”, the dish information providing system 100 may display recipe information items of respective dishes provided by the server 101 in the areas A1 to A7 illustrated in FIG. 10 when displaying the menu on the mobile terminal 102.

(19) In the above-described embodiment, one category is associated with one dish; however, the configuration is not limited to this one.

A plurality of categories may be associated with one dish.

In this case, the server 101 changes the priority in the following manner.

The priority changing unit 223 of the server 101 identifies all categories associated with dish information items whose selection flag value is “1”.

The priority changing unit 223 changes the priority of each dish assigned to the user who has transmitted the selection confirmation information so as to make the priority of a dish information item associated with any of the identified categories lower than the priority of a dish information item not associated with any of the identified categories.

In addition, as for association regarding the techniques, a plurality of techniques may be associated with one dish.

Further, as for association regarding the procedures, a plurality of procedures may be associated with one dish.

(20) In the above-described embodiment, a double tap on a displayed image of a dish is used as an operation for accepting a dish information item provided by the server 101; however, the configuration is not limited to this one. Any given method capable of selecting a dish information item provided by the server 101 may be used. For example, the accepting operation may be performed using radio buttons associated with respective displayed images.

In addition, a flick operation is used as an operation for notifying the server 101 of confirmation of selection; however, the configuration is not limited to this one. Any given operation that triggers transmission may be used. For example, a transmit button may be provided, and the transmission button may be tapped to notify the server 101 of confirmation of selection.

Herein, the term “selection of a dish information item” refers to a combination of an operation for accepting a provided dish information item (e.g., a double tap) and an operation for notifying the server 101 of confirmation of selection (e.g., a flick).

(21) In the above-described embodiment, as for determination of whether or not the user is interested in cooking in the cooking interest mode, the dish information providing system 100 determines that the user is interested in cooking if the log information is updated a predetermined number of times or more per day; however, the configuration is not limited to this one.

Any other method may be used to determine whether or not the user is interested in cooking.

For example, in the case where log information is transmitted only from a specific appliance, the priority changing unit 223 may determine that the user of the appliance is not interested in cooking. Specifically, in the case where only log information from the microwave oven 103 is stored, the priority changing unit 223 determines that the user of the microwave oven 103 is not interested in cooking.

(22) In the above-described embodiment, the dish information providing system 100 changes the priority on the basis of the procedure in the cooking interest mode; however, the configuration is not limited to this one.

Each dish name is associated with a difficulty (e.g., “easy”, “intermediate”, or “difficult”) in preparing a dish indicated by the dish name, and the priority may be changed in accordance with the difficulty.

Specifically, in the case where it is determined that the user is interested in cooking, the priority changing unit 223 makes the priority for a dish information item associated with a lower difficulty than a difficulty of the selected dish lower than the priority for a dish information item associated with a difficulty higher than or equal to a difficulty of the selected dish. Also, in the case where it is determined that the user is not interested in cooking, the priority changing unit 223 makes the priority of a dish information item associated with a difficulty lower than or equal to a difficulty of the selected dish higher than the priority of a dish information item associated with a higher difficulty than a difficulty of the selected dish.

(23) In the above-described embodiment, a dish information item not to be replaced is selected by double tapping when the menu of dish information items for one week is displayed; however, the configuration is not limited to this one.

The dish information providing system 100 may allow the user to select a dish information item to be replaced by double tapping.

In this case, the value of the selection flag associated with the selected dish information item is changed to “1” in the dish information table T500 held by the mobile terminal 102 and the provided dish information table T400 held by the server 101.

In the case where the mode is the “balanced meal mode”, the priority changing unit 223 of the server 101 changes the priority of each dish assigned to the user indicated by the user ID contained in the selection confirmation information received from the mobile terminal 102 so as to make the priority of a dish name associated with the same category as any of categories associated with dish names whose selection flag value is “0” lower than the priority of dish names not associated with any of the categories associated with the dish names whose selection flag value is “0”.

In the case where the mode is the “cooking interest mode” and the user is interested in cooking, the priority changing unit 223 changes the priority of each dish assigned to the user indicated by the user ID contained in selection confirmation information received from the mobile terminal 102 so that the priority for dish names associated with the same procedure as any of procedures associated with dish names whose selection flag value is “0” becomes lower than the priority for dish names not associated with any of the procedures associated with the dish names whose selection flag value is “0”.

In the case where the mode is the “cooking interest mode” and the user is not interested in cooking, the priority changing unit 223 changes the priority of each dish assigned to the user indicated by the user ID contained in selection confirmation information received from the mobile terminal 102 so that the priority for dish names associated with the same procedure as any of procedures associated with dish names whose selection flag value is “0” becomes higher than the priority for dish names not associated with any of the procedures associated with the dish names whose selection flag value is “0”.

(24) The above-described embodiment and each of the exemplary modifications may be combined.

### 1.7 First Supplementary Note

In the case of managing the dish information database, a user and the dish information database can be associated with each other on a one-to-one basis.

In this case, however, a large amount of data is stored in the dish information database which stores dish information items of respective dishes because there are a wide variety of dishes. For this reason, in the case where the dish information database is managed by associating the dish information database and a user on a one-to-one basis, an amount of data to be managed is vast.

In contrast, in the above-described embodiment, one dish information database is managed by associating the dish information database with a plurality of users. This configuration can make the amount of data to be managed smaller than that of the case where the dish information database is managed by associating the dish information database and a user on a one-to-one basis, and thus makes operation of the dish information providing system 100 easier.

In addition, the technique described in the above embodiment can be implemented on the following cloud service models, for example. Note that the models for implementing the technique described in the above-described embodiment are not limited to the ones described below.

### First Service Model: Type of Using Own Data Center

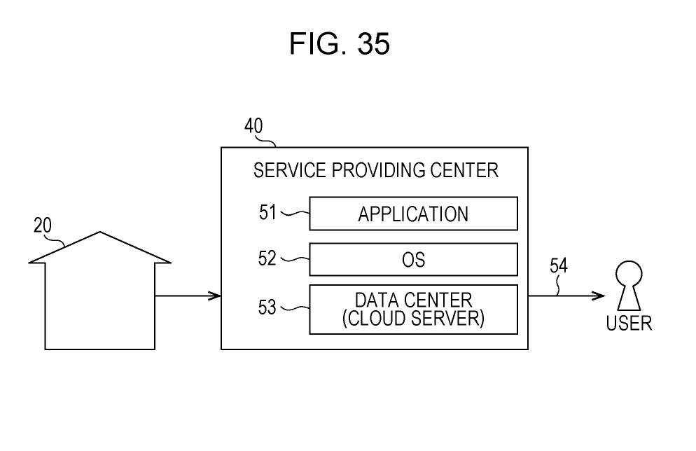

FIG. 35 illustrates a first service model (i.e., type of using an own data center). This model is a model in which the service providing center 40 obtains information from the group 20 and provides a service to a user.

In this model, the service providing center 40 has the functions of the data operation center 30. That is, the service providing center 40 includes a data center (i.e., cloud server) 53 that manages big data. Accordingly, this mode does not include the data operation center 30.

In this model, the service providing center 40 operates and manages the data center (i.e., cloud server) 53. The service providing center 40 also manages an OS 52 and an application 51. The service providing center 40 provides a service by using the OS 52 and the application 51 that are managed by the service providing center 40 (54).

### Second Service Model: Type of Using Infrastructure as a Service (IaaS)

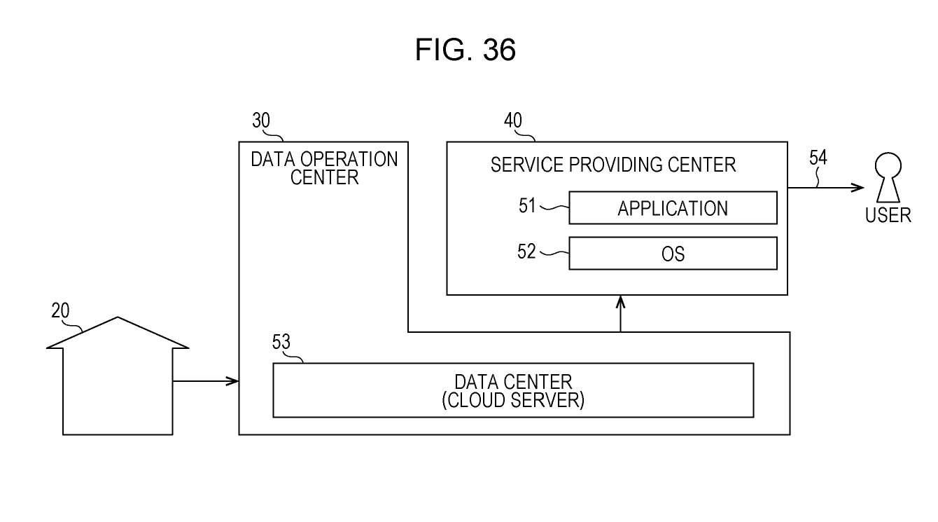

FIG. 36 illustrates a second service model (i.e., type of using IaaS). The term “IaaS” is an abbreviation for infrastructure as a service and refers to a cloud service providing model that provides an infrastructure on which a computer system is constructed and operated is provided as a service via the Internet.

In this model, the data operation center 30 operates and manages the data center (i.e., cloud server) 53. In addition, the service providing center 40 manages the OS 52 and the application 51. The service providing center 40 provides a service by using the OS 52 and the application 51 managed by the service providing center 40 (54).

### Third Service Model: Type of Using Platform as a Service (Paas)

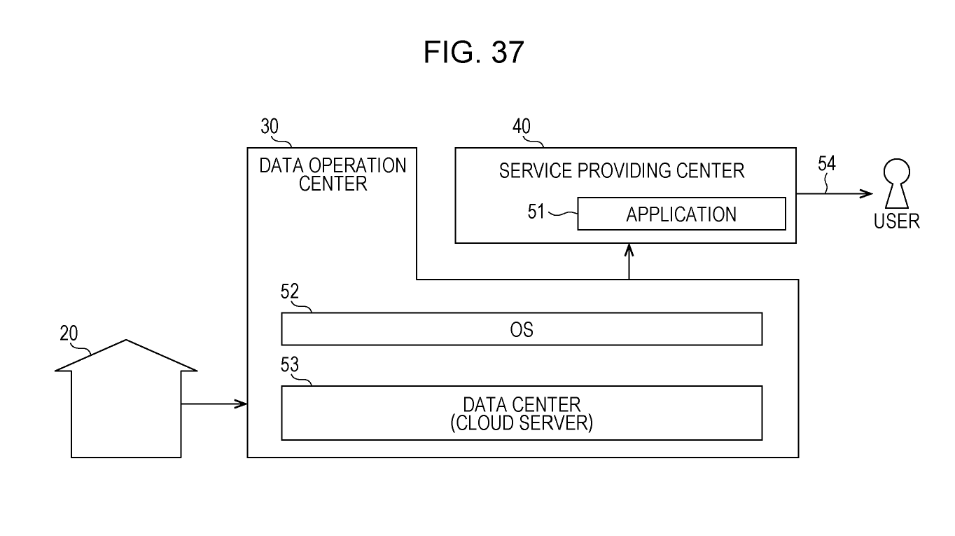

FIG. 37 illustrates a third service model (i.e., type of using PaaS). The term “PaaS” is an abbreviation for platform as a service and refers to a cloud service providing mode that provides a platform serving as a foundation for constructing and operating software is provided as a service via the Internet.

In this model, the data operation center 30 manages the OS 52 and operates and manages the data center (i.e., a cloud server) 53. In addition, the service providing center 40 manages the application 51. The service providing center 40 provides a service by using the OS 52 managed by the data operation center 30 and the application 51 managed by the service providing center 40 (54).

### Fourth Service Model: Type of Using Software as a Service (SaaS)

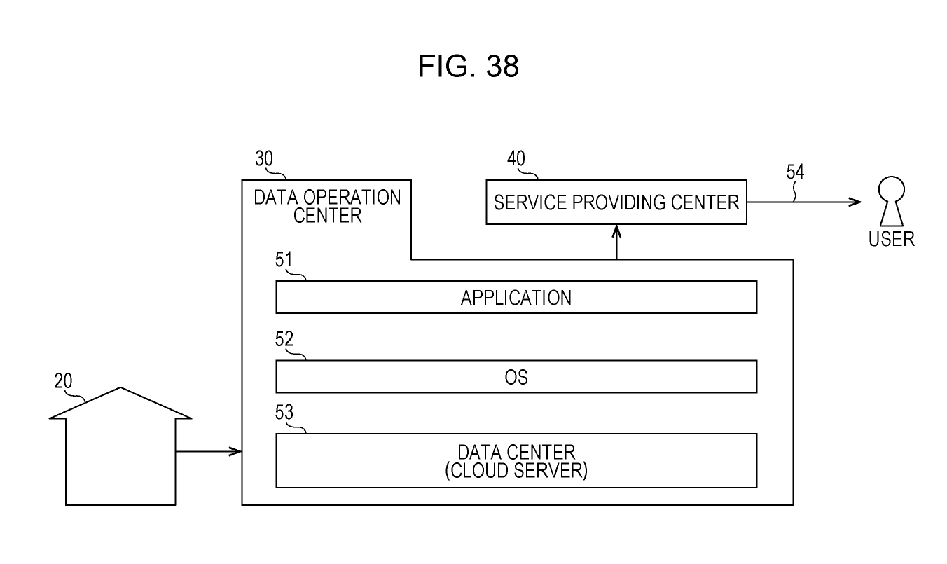

FIG. 38 illustrates a fourth service mode (i.e., type of using SaaS). The term “SaaS” is an abbreviation for software as a service and refers to a cloud service providing model having a function that enables a company or person (user) not owning the data center (i.e., cloud server) 53 to use, via a network such as the Internet, an application provided by a platform provider that owns the data center (i.e., cloud server) 53, for example.

In this model, the data operation center 30 manages the application 51 and the OS 52 and operates and manages the data center (i.e., cloud server) 53. In addition, the service providing center 40 provides a service by using the OS 52 and the application 51 managed by the data operation center 30 (54).

It is assumed that the service providing center 40 provides a service in each of the above-described models. In addition, for example, the service providing center 40 or the data operation center 30 may develop the OS 52, the application 51, or a database storing big data by itself, or let a third party do the development.

### 1.8 Second Supplementary Note

(1) An aspect of the present disclosure feature a dish information providing method including: performing a first process for obtaining the dish information items regarding dishes for the predetermined number of days that are recommended to a user from a dish information database in which the dish information items are stored; providing the user with the obtained dish information items; accepting, from the user, selection of one or more dish information items from among the dish information items provided to the user; performing, in a case where a dish information item among the dish information items provided to the user has not been selected by the user, a second process for obtaining an alternative dish information item that is recommended to the user in place of the not-selected dish information item from the dish information database in accordance with a condition determined from the one or more selected dish information items; and providing the user with the alternative dish information item obtained through the second process.

With this configuration, in the case where there is a dish information item that is not selected by the user among the dish information items provided to the user, an alternative dish information item recommended to the user in place of the not-selected dish information item is obtained in accordance with a condition determined from the selected dish information items. Thus, the dish information providing method can shorten the time up until dishes for the predetermined number of days are confirmed.

For example, if the condition determined from the selected dish information items indicates that dish information associated with a different category from categories associated with the selected dish information items is preferentially selected, the dish information providing method enables dish information items for the predetermined number of days to be provided to the user by taking the nutrition balance into account without inclination to one category.

(2) For example, the dish information items stored in the dish information database may be associated with respective categories based on dishes indicated by the corresponding dish information items in the dish information database. Subsequent to the selection of the one or more dish information items and prior to the second process, priorities may be set for the respective dish information items stored in the dish information database so that a dish information item not associated with any of the categories associated with the one or more selected dish information items is obtained preferentially over a dish information item associated with a category identical to any of the categories associated with the one or more selected dish information items. In the second process, the alternative dish information item may be obtained from the dish information database in accordance with the priorities set for the dish information items stored in the dish information database.

With this configuration, a dish information item not associated with any of the categories associated with the selected dish information items is obtained in place of the not selected dish information item, in accordance with the set priority. Accordingly, the dish information providing method enables dish information items for a predetermined number of days to be provided to the user from a wide variety of categories without inclination to one category, and can shorten the time up until the user who desires to be provided with dishes of a wide variety of categories confirms dish information items for the predetermined number of days.

(3) For example, the dish information items stored in the dish information database may be pre-assigned respective priorities in the dish information database. The priorities of the dish information items stored in the dish information database may be changed so that the priority assigned to a dish information item associated with a category identical to any of the categories associated with the one or more selected dish information items becomes lower than the priority assigned to a dish information item not associated with any of the categories associated with the one or more selected dish information items.

With this configuration, the priority of each dish information item is changed so that the priority of a dish information item associated with any of the categories associated with the selected dish information items becomes lower than the priority of a dish information item associated with a category different from these categories. Thus, the dish information providing method enables dish information items for the predetermined number of days to be provided to the user from a wide variety of categories.

(4) For example, in a case where an instruction to deselect a dish information item that has been selected by the user may further be accepted from the user, the priority assigned to the deselected dish information item stored in the dish information database may be changed so that the resulting priority becomes lower than the priority assigned to the deselected dish information item during the first process.

With this configuration, the priority of dish information that has once been selected and then deselected is lowered. In this way, the dish information providing method can decrease a possibility of the dish information item being selected again.

(5) For example, in a case where selection of all the dish information items provided to the user is accepted from the user, the priorities assigned to the dish information items stored in the dish information database may be changed so that the priority assigned to a dish information item that is associated with a category identical to any of the categories associated with the one or more selected dish information items and that is not selected by the user becomes higher than the priority assigned to the dish information item during the first process. After all the dish information items for a first period constituted by the predetermined number of days provided to the user have been selected, dish information items for a second period constituted by the predetermined number of days that is different from the first period may be obtained from the dish information database in accordance with the priorities that have been changed, and the obtained dish information items may be provided to the user.

With this configuration, in the case of providing dish information items for a period other than the period for which all the dish information items have been selected, the dish information providing method enables dish information items other than the selected dish information items to be preferentially provided.

(6) For example, the dish information items stored in the dish information database may be associated with respective categories each indicating a procedure for preparing a dish indicated by the corresponding dish information item. User information related to cooking may further be obtained. Prior to the second process, priorities assigned to respective dish information items each associated with a category identical to any of the categories associated with the one or more selected dish information items may be set in accordance with the user information. In the second process, the alternative dish information item may be obtained from the dish information database in accordance with the priorities set for the dish information items stored in the dish information database.

With this configuration, an alternative dish information item for the not-selected dish information is obtained through the second process in accordance with the priority set based on the user information in the dish information providing method. Consequently, in the case where the priority of each dish information item is changed so that a dish information item not associated with any of the categories associated with the selected dish information items is preferentially obtained, the dish information providing method enables dish information items for a predetermined number of days to be provided to the user from a wide variety of categories without inclination to a specific category (procedure).

(7) For example, the user information may be cooking history information indicating cooking performed by the user. Whether or not the user is interested in cooking may be determined using the cooking history information. In a case where it is determined that the user is interested in cooking, the priorities assigned to the dish information items stored in the dish information database may be changed so that the priority assigned to a dish information item associated with a category identical to any of the categories associated with the one or more selected dish information items becomes lower than the priority assigned to a dish information item not associated with any of the categories associated with the one or more selected dish information items. In a case where it is determined that the user is not interested in cooking, the priorities assigned to the dish information items stored in the dish information database may be changed so that the priority assigned to a dish information item associated with a category identical to any of the categories associated with the one or more selected dish information items becomes higher than the priority assigned to a dish information item not associated with any of the categories associated with the one or more selected dish information items.

With this configuration, whether or not the user is interested in cooking is determined by using cooking history information which serves as user information, and the priority is set in accordance with the determination result in the dish information providing method. Specifically, in the case where it is determined that the user is interested in cooking, dish information items for the predetermined number of days are provided from a wide variety of categories without inclination to the categories (procedures) indicated by the selected dish information items. In the case where it is determined that the user is not interested in cooking, dish information items for a predetermined number of days are provided to the user from the categories (procedures) of dishes indicated by the selected dish information items. This allows the user who is interested in cooking to cook a wide variety of dishes and allows the user who is not interested in cooking to cook dishes for the predetermined number of days by performing the procedure which the user can perform.

(8) For example, the cooking history information may be log information related to the user's use of home electric appliances for cooking. In a case where the number of times the log information has been updated is greater than or equal to a predetermined value, it may be determined that the user is interested in cooking. In a case where the number of times the log information has been updated is less than the predetermined value, it may be determined that the user is not interested in cooking.

With this configuration, in the dish information providing method, whether or not the user is interested in cooking can be determined by using log information related to the user's use of home electric appliances for cooking as the cooking history information.

(9) For example, the user information may be information indicating a category preferred by the user. In a case where the category indicated by the user information matches any of the categories associated with the one or more selected dish information items, the priorities assigned to the dish information items stored in the dish information database may be changed so that the priority assigned to a dish information item associated with a category identical to the category indicated by the user information becomes higher than the priority assigned to a dish information item not associated with the category indicated by the user information. In a case where the category indicated by the user information does not match any of the categories associated with the one or more selected dish information items, the priorities assigned to the dish information items stored in the dish information database may be changed so that the priority assigned to a dish information item associated with a category identical to any of the categories associated with the one or more selected dish information items becomes lower than the priority assigned to a dish information item not associated with any of the categories associated with the one or more selected dish information items.

With this configuration, the priority of each dish information item is set by using, as the user information, information indicating a category of dishes preferred by the user and the categories of the selected dish information items in the dish information providing method. Accordingly, because dish information items associated with a category of dishes preferred by the user are preferentially provided in the dish information providing method, a possibility of the provided dish information items being accepted by the user increases and the time up until dishes for the predetermined number of days are confirmed can be reduced.

(10) For example, the dish information items stored in the dish information database may be associated with meal type information in the dish information database, the meal type information indicating at least one of breakfast, lunch, dinner, and snack for which a dish indicated by a dish information item is suitable. In the first process and the second process, dish information items associated with a first meal type indicated by the meal type information may be obtained from the dish information database. The dish information items obtained from the dish information database may be provided to the user after the first process or the second process by causing a mobile terminal to display the dish information items. In a case where an instruction to switch the meal type to a second meal type different from the first meal type may be accepted from the user while the dish information items are displayed by the mobile terminal, dish information items for the predetermined number of days may be obtained from among dish information items associated with the meal type information indicating the second meal type from the dish information database, and the mobile terminal may be caused to switch to the dish information items obtained based on the second meal type from the dish information items associated with the first meal type.

With this configuration, dish information items for the predetermined number of days can be provided on a meal type basis in the dish information providing method. Accordingly, because the user is provided with dish information items for the predetermined number of days for a desired meal type (e.g., dinner), the provided dish information items can help the user deciding on a meal plan for the predetermined number of days for the meal type indicated by the meal type information.

(11) For example, the dish information items stored in the dish information database may be associated with dish type information in the dish information database, the dish type information indicating which of a main dish or a side dish of a meal a dish indicated by a dish information item corresponds to. In the first process and the second process, dish information items associated with a first dish type indicated by the dish type information may be obtained from the dish information database. The dish information items obtained from the dish information database may be provided to the user after the first process or the second process by causing a mobile terminal to display the dish information items. In a case where an instruction to switch the dish type to a second dish type different from the first dish type may be accepted from the user while the dish information items are displayed by the mobile terminal, dish information items for the predetermined number of days may be obtained from among dish information items associated with the dish type information indicating the second dish type from the dish information database, and the mobile terminal may be caused to switch to the dish information items obtained based on the second dish type from the dish information items associated with the first dish type.

With this configuration, dish information items for the predetermined number of days can be provided on a dish type basis in the dish information providing method. Accordingly, because the user is provided with dish information items regarding a desired dish type (e.g., side dish) for a predetermined number of days, for example, the provided dish information items help the user deciding on a meal plan when a meal plan of side dishes for the predetermined number of days is not decided.

(12) For example, the dish information items each may contain nutrition information indicating a nutritional value of a dish indicated by the dish information item. The dish information items recommended to the user may be provided after the first process or the second process by causing a mobile terminal to display the dish information items. In a case where the dish information items are displayed by the mobile terminal after the second process, the nutrition information associated with the dish information item obtained through the second process and the nutrition information associated with the dish information items that have been obtained through the first process and selected by the user may be displayed by the terminal in different colors.

With this configuration, the nutrition values of dishes indicated by the selected dish information items and the nutrition values of dishes indicated by the not-selected dish information items are displayed in different colors in the dish information providing method. Accordingly, the user can distinguish at a glance the nutrition values of dishes indicated by the selected dish information items and the nutrition values of dishes indicated by the not-selected dish information items from each other.

(13) For example, in the first process, a dish information item may be obtained for each day of the predetermined number of days. Each of the dish information items obtained for a corresponding day through the first process may be provided to the user in association with the day. In the second process, an alternative dish information item may be obtained for each day associated with a not-selected dish information item. The alternative dish information item obtained for a corresponding day associated with the not-selected dish information item through the second process may be provided to the user in association with the day.

With this configuration, because a dish information item is provided to the user in association with each day in the dish information providing method, the user can select the dish information item on a day-by-day basis. As a result, the user can decide on a meal plan for the predetermined number of days on a day-by-day basis, for example.

The dish information providing method and system according to aspects of the present disclosure are effective for a service for providing dish information items of dishes for a predetermined number of days.

What is claimed is:

1. A dish information providing method comprising:
performing a first process for obtaining the dish information items regarding dishes for the predetermined number of days that are recommended to a user from a dish information database in which the dish information items are stored;
providing the user with the obtained dish information items;
accepting, from the user, selection of one or more dish information items from among the dish information items provided to the user;
performing, in a case where a dish information item among the dish information items provided to the user has not been selected by the user, a second process for obtaining an alternative dish information item that is recommended to the user in place of the not-selected dish information item from the dish information database in accordance with a condition determined from the one or more selected dish information items; and
providing the user with the alternative dish information item obtained through the second process.

2. The dish information providing method according to claim 1, wherein
the dish information items stored in the dish information database are associated with respective categories based on dishes indicated by the corresponding dish information items in the dish information database,
subsequent to the selection of the one or more dish information items and prior to the second process, priorities are set for the respective dish information items stored in the dish information database so that a dish information item not associated with any of the categories associated with the one or more selected dish information items is obtained preferentially over a dish information item associated with a category identical to any of the categories associated with the one or more selected dish information items, and
in the second process, the alternative dish information item is obtained from the dish information database in accordance with the priorities set for the dish information items stored in the dish information database.

3. The dish information providing method according to claim 2, wherein
the dish information items stored in the dish information database are pre-assigned respective priorities in the dish information database, and
the priorities of the dish information items stored in the dish information database are changed so that the priority assigned to a dish information item associated with a category identical to any of the categories associated with the one or more selected dish information items becomes lower than the priority assigned to a dish information item not associated with any of the categories associated with the one or more selected dish information items.

4. The dish information providing method according to claim 3, wherein
in a case where an instruction to deselect a dish information item that has been selected by the user is further accepted from the user, the priority assigned to the deselected dish information item stored in the dish information database is changed so that the resulting priority becomes lower than the priority assigned to the deselected dish information item during the first process.

5. The dish information providing method according to claim 3, wherein
in a case where selection of all the dish information items provided to the user is accepted from the user,
the priorities assigned to the dish information items stored in the dish information database are changed so that the priority assigned to a dish information item that is associated with a category identical to any of the categories associated with the one or more selected dish information items and that is not selected by the user becomes higher than the priority assigned to the dish information item during the first process, and
after all the dish information items for a first period constituted by the predetermined number of days provided to the user have been selected, dish information items for a second period constituted by the predetermined number of days that is different from the first period are obtained from the dish information database in accordance with the priorities that have been changed, and the obtained dish information items are provided to the user.

6. The dish information providing method according to claim 1, wherein
the dish information items stored in the dish information database are associated with respective categories each indicating a procedure for preparing a dish indicated by the corresponding dish information item,
user information related to cooking is further obtained,
prior to the second process, priorities assigned to respective dish information items each associated with a category identical to any of the categories associated with the one or more selected dish information items are set in accordance with the user information, and
in the second process, the alternative dish information item is obtained from the dish information database in accordance with the priorities set for the dish information items stored in the dish information database.

7. The dish information providing method according to claim 6, wherein
the user information is cooking history information indicating cooking performed by the user,
whether or not the user is interested in cooking is determined using the cooking history information,
in a case where it is determined that the user is interested in cooking, the priorities assigned to the dish information items stored in the dish information database are changed so that the priority assigned to a dish information item associated with a category identical to any of the categories associated with the one or more selected dish information items becomes lower than the priority assigned to a dish information item not associated with any of the categories associated with the one or more selected dish information items, and
in a case where it is determined that the user is not interested in cooking, the priorities assigned to the dish information items stored in the dish information database are changed so that the priority assigned to a dish information item associated with a category identical to any of the categories associated with the one or more selected dish information items becomes higher than the priority assigned to a dish information item not associated with any of the categories associated with the one or more selected dish information items.

8. The dish information providing method according to claim 7, wherein
the cooking history information is log information related to the user's use of home electric appliances for cooking,
in a case where the number of times the log information has been updated is greater than or equal to a predetermined value, it is determined that the user is interested in cooking, and
in a case where the number of times the log information has been updated is less than the predetermined value, it is determined that the user is not interested in cooking.

9. The dish information providing method according to claim 6, wherein
the user information is information indicating a category preferred by the user,
in a case where the category indicated by the user information matches any of the categories associated with the one or more selected dish information items, the priorities assigned to the dish information items stored in the dish information database are changed so that the priority assigned to a dish information item associated with a category identical to the category indicated by the user information becomes higher than the priority assigned to a dish information item not associated with the category indicated by the user information, and
in a case where the category indicated by the user information does not match any of the categories associated with the one or more selected dish information items, the priorities assigned to the dish information items stored in the dish information database are changed so that the priority assigned to a dish information item associated with a category identical to any of the categories associated with the one or more selected dish information items becomes lower than the priority assigned to a dish information item not associated with any of the categories associated with the one or more selected dish information items.

10. The dish information providing method according to claim 1, wherein
the dish information items stored in the dish information database are associated with meal type information in the dish information database, the meal type information indicating at least one of breakfast, lunch, dinner, and snack for which a dish indicated by a dish information item is suitable,
in the first process and the second process, dish information items associated with a first meal type indicated by the meal type information are obtained from the dish information database,
the dish information items obtained from the dish information database are provided to the user after the first process or the second process by causing a mobile terminal to display the dish information items,
in a case where an instruction to switch the meal type to a second meal type different from the first meal type is accepted from the user while the dish information items are displayed by the mobile terminal, dish information items for the predetermined number of days are obtained from among dish information items associated with the meal type information indicating the second meal type from the dish information database, and the mobile terminal is caused to switch to display of the dish information items obtained based on the second meal type from display of the dish information items associated with the first meal type.

11. The dish information providing method according to claim 1, wherein
the dish information items stored in the dish information database are associated with dish type information in the dish information database, the dish type information indicating which of a main dish or a side dish of a meal a dish indicated by a dish information item corresponds to,
in the first process and the second process, dish information items associated with a first dish type indicated by the dish type information are obtained from the dish information database,
the dish information items obtained from the dish information database are provided to the user after the first process or the second process by causing a mobile terminal to display the dish information items,
in a case where an instruction to switch the dish type to a second dish type different from the first dish type is accepted from the user while the dish information items are displayed by the mobile terminal, dish information items for the predetermined number of days are obtained from among dish information items associated with the dish type information indicating the second dish type from the dish information database, and the mobile terminal is caused to switch to the dish information items obtained based on the second dish type from the dish information items associated with the first dish type.

12. The dish information providing method according to claim 1, wherein
the dish information items each contain nutrition information indicating a nutritional value of a dish indicated by the dish information item,
the dish information items recommended to the user are provided after the first process or the second process by causing a mobile terminal to display the dish information items, and
in a case where the dish information items are displayed by the mobile terminal after the second process, the nutrition information associated with the dish information item obtained through the second process and the nutrition information associated with the dish information items that have been obtained through the first process and selected by the user are displayed by the mobile terminal in different colors.

13. The dish information providing method according to claim 1, wherein
in the first process, a dish information item is obtained for each day of the predetermined number of days,
each of the dish information items obtained for a corresponding day through the first process is provided to the user in association with the day,
in the second process, an alternative dish information item is obtained for each day associated with a not-selected dish information item, and
the alternative dish information item obtained for a corresponding day associated with the not-selected dish information item through the second process is provided to the user in association with the day.

14. A system comprising:
one or more memories; and
circuitry, which in operation:
obtains the dish information items regarding dishes for the predetermined number of days that are recommended to a user from a dish information database in which the dish information items are stored;
provides the user with the obtained dish information items;
accepts, from the user, selection of one or more dish information items from among the dish information items provided to the user;
obtains, in a case where a dish information item among the dish information items provided to the user has not been selected by the user, an alternative dish information item that is recommended to the user in place of the not-selected dish information item from the dish information database in accordance with a condition determined from the one or more selected dish information items; and
provides the user with the alternative dish information item.
